(19) United States
(12) Patent Application Publication
(10) Pub. No.: US 2025/0111677 A1
(43) Pub. Date: Apr. 3, 2025

(54) NEW NON-INVASIVE FULLY AUTOMATED SYSTEM IDENTIFYING AND CLASSIFYING VEHICLES AND MEASURING EACH VEHICLE'S WEIGHT, DIMENSION, VISUAL CHARACTERISTICS, ACOUSTIC PATTERN AND NOISE IN REAL-TIME WITHOUT INTERFERING WITH THE TRAFFIC

(71) Applicant: STL Scientific LLC, Temple City, CA (US)

(72) Inventor: Shervin Taghavi Larigani, Temple City, CA (US)

(73) Assignee: STL Scientific LLC, Temple City, CA (US)

(21) Appl. No.: 18/833,159

(22) PCT Filed: Jan. 25, 2023
(86) PCT No.: PCT/US23/61291

§ 371 Date: Jul. 25, 2024

Related U.S. Application Data
(60) Provisional application No. 63/407,662, filed on Sep. 18, 2022.
(60) Provisional application No. 63/368,652, filed on Jul. 17, 2022.
(60) Provisional application No. 63/302,964, filed on Jan. 25, 2022.

(51) Int. Cl. G06V 20/54; G01G 19/03; G01M 5/00; G06V 10/82

(52) U.S. Cl. CPC G06V 20/54; G01G 19/03; G01M 5/0008; G01M 5/0066; G01M 5/0091; G06V 10/82; G06V 2201/08

(57) ABSTRACT

A vehicle monitoring system for determining one or more identifying characteristics of one or more vehicles traversing a bridge, including a plurality of sensor devices capturing electromagnetic signal or acoustic signals transmitted from a bridge and/or one or more vehicles traversing the bridge; and a computer system determining, from the signals, the one or more identifying characteristics comprising a weight distribution of one or more of the vehicles.

### CROSS REFERENCE TO RELATED APPLICATIONS

This application claims the benefit under 35 U.S.C. Section 119(e) of co-pending and commonly-assigned U.S. provisional patent application Serial Nos.
63/302,964, filed on Jan. 25, 2022, by Shervin Taghavi, entitled “NEW NON-INVASIVE AUTOMATED SYSTEM TO MEASURE VEHICLE'S WEIGHT, DIMENSION, AND NOISE IN REAL TIME WITHOUT INTERFERING WITH THE TRAFFIC,” and
63/368,652, filed on Jul. 17, 2022, by Shervin Taghavi Larigani, entitled “NEW NON-INVASIVE FULLY AUTOMATED SYSTEM IDENTIFYING AND CLASSIFYING VEHICLES AND MEASURING EACH VEHICLE'S WEIGHT, DIMENSION, VISUAL CHARACTERISTICS, ACOUSTIC PATTERN AND NOISE IN REAL-TIME WITHOUT INTERFERING WITH THE TRAFFIC; and
63/407,662, filed on Sep. 18, 2022, by Shervin Taghavi Larigani, entitled “METHOD FOR DETERMINING THE NUMBER OF AXLES, AXLE WEIGHTS, AXLE SEPARATIONS, AND VEHICLE SPEED AS WELL AS A METHOD FOR DETERMINING IF A VEHICLE'S MAXIMUM STRESS ON THE ROAD EXCEEDS THE PERMITTED LIMIT USING THE MOTION THAT THE VEHICLE INDUCED ON THE BRIDGE AS IT TRAVERSES”; and

All of which applications are incorporated by reference herein.

### STATEMENT REGARDING FEDERALLY SPONSORED RESEARCH AND DEVELOPMENT

This invention was made with government support under NSF SBIR Phase II 2051992 awarded by the National Science Foundation. The government has certain rights in the invention.

### BACKGROUND OF THE INVENTION

### 1. Field of the Invention

The present invention relates to a non-invasive automated system and method for measuring a vehicle's weight, dimension, noise, speed, license plate number, the type of the vehicle, and/or the vehicle's Department of Transportation number in the case of a commercial vehicle, simultaneously without interfering with traffic. Moreover, the same system determines in real-time the dynamics of the monitoring bridge.

### 2. Related Art

Trucks are routinely weighed at weigh stations to determine if the trucks are overweight and liable to cause damage to the roadways. However, conventional systems requrire stopping the trucks at weighstations, a time consuming ane expensive procedure. What is needed is a less invasive method for measuring truck weight distributions. The present invention satisfies this need.

### SUMMARY OF THE INVENTION

Example methods, devices and systems according to embodiments described herein include, but are not limited to, the following:

1. A vehicle monitoring system for determining one or more identifying characteristics of one or more vehicles traversing a bridge, comprising:
a plurality of sensor devices capturing electromagnetic signal or acoustic signals transmitted from a bridge and/or one or more vehicles traversing a bridge; and
a computer system determining, from the signals, the one or more identifying characteristics comprising a weight distribution of one or more of the vehicles (e.g., using machine learning/AI, a neural network, or curve fitting).

2. The system of example 1, wherein:
the computer system determines, from the signals, the one or more identifying characteristics of one or more of the vehicles comprising axles connected to tires, and
the characteristics comprise at least one of a department of transportation number, license plate number, a classification of the vehicles, a number of the axles on the vehicle, a number of the tires making contact with the bridge, a separation of the axles, a distance of the axles to an end of the bridge, or a speed of the vehicle.

3. The system of example 2, wherein:
at least one of the sensor devices comprises a traffic camera capturing the signals comprising video images of the vehicles traversing the bridge, and
the computer system determines the identifying characteristics from the video images using computer vision or an artificial intelligence algorithm.

4. The system of example 1, wherein:
at least one of the sensor devices comprises a rangefinder irradiating the bridge with the signals comprising electromagnetic radiation, and
the rangefinder determines a displacement of the bridge as a function of time in response to the vehicles traversing the bridge, by measuring changes in a distance to the bridge from changes in a time of flight of the electromagnetic radiation to the bridge or interferometry of the electromagnetic radiation, and
the computer system determines the weight distribution by analyzing the displacement of the bridge.

5. The system of example 1, wherein:
at least one of the sensor devices comprises one or more acoustic sensors beaming and/or receiving the signals comprising acoustic signals from the bridge and/or the vehicles on the bridge, and
the acoustic sensors or the acoustic sensors in combination with one or more processors determine at least one of:
a displacement of the bridge as a function of time in response to the vehicles traversing the bridge, by measuring changes in a distance to the bridge from changes in a time of flight of the acoustic signals to the bridge or a triangulation method, the computer system determining the weight distribution from the displacement, or
the one or more identifying characteristics of one or more of the vehicles by analyzing an acoustic signature of the acoustic signals.

6. The system of example 1, further comprising one or more targets attached to the bridge, wherein:
at least one of the sensor devices comprises a digital camera capturing the signals comprising video images of the target moving in response to the vehicles traversing the bridge, wherein the video images are marked with a first stamp; and
the computer system:
determines a displacement as a function of time of the one or more targets from the video images, and
determines the weight distribution from the displacement.

7. The system of example 6, wherein:
at least one of the sensor devices comprises a traffic camera capturing traffic video images of the vehicles marked a second time stamp so that the traffic video images can be time synchronized to the displacement.

8. The system of example 1, wherein:
at least one of the sensor devices comprises a traffic camera collecting the signals comprising forming video images of the vehicles on a bridge, wherein the video images comprise image frames comprising pixels;
at least one of the sensor devices measures a set of training displacements of the bridge caused by the vehicles traversing the bridge; and
the computer system executes a training algorithm:
requesting first inputs, for each of a plurality of image frames in the video images, identifying which of the pixels are associated with one of the vehicles, so that the computer system obtains a training distribution of the pixels representing a positioning of the vehicles in the each of the image frames;
requesting second inputs comprising a set of the training displacements of the bridge time synchronized to the image frames;
creates a training set comprising the training distributions of pixels associated with the training displacements; and
trains a neural network using the training set to obtain a trained neural network, so that the trained neural network is trained to output a displacement of the bridge in response to an input comprising a distribution of pixels representing positioning of vehicles on the bridge.

9. The system of example 8, wherein the at least one sensor measuring the training displacements comprises:
a rangefinder measuring the training displacements by measuring changes in a distance to the bridge as a function of time, or
a camera system recording the training displacements comprising a displacement as a function of time of one or more targets attached to the bridge.

10. The system of example 1, wherein:
at least one of the sensor devices comprises a traffic camera collecting the signals forming video images of the vehicles on the bridge, the video images comprising image frames comprising pixels;
at least one of the sensor devices measures of a displacement as a function of time of the bridge caused by the one or more vehicles traversing the bridge; and
the computer system executes a neural network determining:
a distribution of pixels in one or more of the image frames identifying locations of the one or more vehicles on the bridge in response to the displacement of the bridge inputted to the neural network,
determining the weight distribution by assigning a magnitude the displacement at each of the locations.

11. The system of example 10, wherein the computer system:
calibrates the weight distribution using a known weight of a vehicle so that the weight distribution of each of the vehicles at each of the locations can be determined using the calibration, or
outputs a comparative weight of the vehicles from the weight distribution.

13. The system of example 1, wherein:
at least one of the sensor devices comprises a traffic camera collecting the signals forming video images of the vehicles on a bridge;
at least one of the sensor devices measures a displacement as a function of time of the bridge caused by the vehicles traversing the bridge;
the computer system:
time synchronizes the images to the displacement;
recognizes the vehicles in the video images; and
determines the weight distribution of one or more of the vehicles by:
associating a segment of the displacement with one of the vehicles recognized in the video image; and
fitting the segment using a mathematical model or by identifying a peak in the displacement above a threshold level indicating that a stress on the bridge exceeds an acceptable level.

14. The system of example 1,
at least one of the sensor devices comprises a traffic camera collecting the signals forming video images of the vehicles on the bridge;
at least one of the sensors devices measures a displacement of the bridge in response to the vehicles traversing the bridge; and
the computer system determines the weight distribution by:
recognizing one of the vehicles in the video images;
associating a segment of the displacement with the one of the vehicles recognized in the video images; and
curve fitting the segment to determine the weight distribution.

15. The system of example 14, wherein:
the at least one sensor measuring the displacement comprises a digital camera capturing images of the displacement a as a function of time of one or more markers attached to the bridge as the vehicles traverse the bridge; and
the computer system:
obtains a number of contact points of point loads of the vehicles traversing the bridge;
obtains a distance of the markers from supports on the bridge and a separation of the point loads;
obtains a plurality of curves representing a response of the bridge to each of the point loads;
obtains an estimate of the speed of the vehicle;
performs the curve fitting by summing each of the curves, using a temporal distance between the curves set by the separation divided by the speed, each of the curves having a spread and maximum peak scaled by the distance of the marker to the supports on the bridge, so as to obtain fitted data; and
uses the fitted data to identify each of the point loads in the displacement, so as to determine the weight distribution comprising which of the point loads causes the most stress on the bridge.

16. The system of example 15, wherein the computer system determines at least one of the number of contact points, the speed, the distance of the markers, and the separation of the point loads using a machine learning algorithm or computer vision analysing the video images outputted from the traffic camera.

17. The system of example 15, wherein at least one of the sensor devices comprises a rangefinder determining the distance of the markers and the separation of the point loads.

18. The system of example 1, wherein the sensor devices automatically capture the signals and the computer automatically determines the weight distribution from the signals once the system is activated.

19. The system of example 1, further comprising:
at least one of the sensor devices comprising a traffic camera collecting the signals forming video images of vehicles on a bridge;
at least one of the sensor devices measures a displacement of the bridge caused by a plurality of vehicles traversing the bridge; and
the computer system:
determines from the displacement, a contribution to the displacement caused by a single one of the vehicles as if the single one of the vehicles were the only vehicle traversing the bridge, and
determines the weight distribution from the contribution.

An internet of things (IoT) system comprising the system of example 1,
at least one of the sensor devices comprises a traffic camera collecting the signals forming video images of the vehicles on a bridge;
at least one of the sensor devices measures a displacement as a function of time of the bridge caused by the vehicles traversing the bridge;
the IoT system further comprising:
one or more edge devices comprising one or more processors executing machine learning or computer vision to identify vehicles in the one or more video images;
the computer system comprising one or more servers or a cloud system determining the weight distribution of one or more of the vehicles by associating a segment of the displacement with one of the vehicles recognized in the video image time synchronized to the segment; and
a hub linking the servers or the cloud system to the edge devices and the sensor devices.

21. The system of example 1,
at least one of the sensor devices measures a displacement of the bridge caused by a plurality of vehicles traversing the bridge; and
the computer system identifies components of the displacement associated with a structural characteristic of the bridge, wherein the components are useful for monitoring a health status of the bridge.

22. A system deducing. the weight of vehicles traversing a bridge by combining the time-series displacement of point target(s) on the bridge with the location of each vehicle at each instant on the bridge. It may uses super-high resolution camera system and laser system to measure the time-series displacement of visual target(s) and uses traffic camera(s) and microphone(s) to detect the location of vehicles.

23. A system measuring vehicles' gross and axles weight.

24. A system using open-source and custom-trained AI and deep learning algorithms to the image of the vehicle traversing the bridge to determine vehicle sizes, dimensions, and visual characteristics. In parallel with this, a second vehicle classification is accomplished by applying artficial intelligence (AI) and deep learning algorithms to the deflection time-series of the bridge caused by the vehicle's passage.

25. A system classifies a vehicle based on its noise pattern using open-source and custom trained AI and deep learning algorithms.

26. In one or more examples, the computer implements a training a neural network algorithm having inputs comprising the locations of the vehicle on the bridge and the outputs comprising the deflection(s) of the visual target(s)

### BRIEF DESCRIPTION OF THE DRAWINGS

Referring now to the drawings in which like reference numbers represent corresponding parts throughout:

FIG. 1. Schematic of a system for determining at least one characteristics of one or more vehicles traversing a bridge (+ symbol means combine).

FIG. 2. Illustration of a sensor comprising a camera system used for measuring deflections of one or more targets on a bridge.

FIG. 3A shows a set up where an optical range finder is used to measure the deflection of a beam bridge. The rangefinder comprises a laser shining onto a target. From changes in the range between the range finder and the target, it is possible to calculate the time-series deflection of the bridge.

FIG. 3B shows a set up where microphones are used to measure the deflection of a beam bridge using an acoustic trilateration method for assigning acoustic signature to each vehicle using a series of synchronized acoustic sensors such as microphones installed around the bridge.

FIG. 4 Example system comprising a hub.

FIG. 5: applying AI and deep learning object detection and tracking algorithms to the traffic-video images. We detect different type of objects and associate to each new object appearing in the video-images a new id to track it from one frame to the next one until it goes out. FIG. 5 shows an example of one or more live of the traffic to detect and track each vehicle on a bridge so as gain knowledge of each vehicle's location at each instant in time. In one or more examples, the traffic video images are streamed from flying drones observing the traffic.

FIG. 6A: Example Neural Network wherein the inputs to the neural network are the pixel in the traffic video-image and the output to the neural network is the displacement time-series of one point target.

FIG. 6B: Example neural network wherein the output of the neural network is the displacement time-series of multiple point targets or all point targets.

FIG. 7: Traffic video frame with lattice representing the inputs of the neural network

FIG. 8A: Traffic video frame wherein the black points represent the input node that are excited.

FIG. 8B shows how stereovision allows us to view traffic on the bridge in three dimensions (3D) using multiple traffic cameras. Each point load is an input to the neural network in this case and the stereovision enables addtional inputs to the convolution neural network.

FIG. 9. Flowchart illustrating a method of training a neural network.

FIG. 10. Flowchart illustrating a method of using a trained neural network to determine load distribution.

FIG. 11. View of a single truck traversing a beam bridge along its length. The truck is modelled as a series of point loads, each corresponding to an axle FIG. 12 shows the transverse view of the same truck.

FIG. 13 illustrates the effect of a concentrated point load P on a simply supported beam of length l, y is the deflection of the beam at a location x of the beam, wherein the deflection of the bridge at location x is y, E is the elastic modulus and I is the second moment of area of the beam's cross section, a is the distance between the point load the front end of the bridge, b is the distance between the point load and the back end of the bridge.

FIG. 14 illustrates the deflection of a bridge modeled using a beam equation and as a result of an 80,000 Lbs. static point loads applied at different locations. The bridge is 30 m long and has a moment of inertia of 274 mm⁴ and elastic constant of 200 GPa.

FIG. 15 shows the deflection caused by a 2-axle vehicle traversing the bridge using a static model.

FIG. 16 illustrates application of the Yolov object detection and tracking algorithm to a simulation of real-time traffic video on a GPU-enabled virtual IoT edge machine. At every video image, each vehicle is detected, identified, and tracked. This is done at a rate of 30 frames per second.

FIG. 17 illustrates how the curve fitting technique is used to decompose the measurement data into a series of deflections caused by single point loads. Each single point load deflection corresponds to a deflection of a truck axle. The intensity of each peak is proportional to the weight of each axle.

FIG. 18 illustrates markers on a two lane bridge.

FIG. 19A illustrates raw data of the time series of deflections showing the passage of multiple trucks on a bridge.

FIG. 19B is a zoomed in view of the time series displacement showing how each of the trucks influence the displacement profile.

FIG. 19C shows a time series displacement and a segment from which one truck passing event is selected for curve fitting.

FIG. 19C shows a single lane on a bridge an point loads on multiple vehicles.

FIG. 19D shows a single lane with multiple trucks each having point loads that can be identified using curve fitting.

FIG. 20 is a flowchart illustrating a method of flagging vehicles having the load distribution applying stress above a threshold value.

FIG. 21 illustrates a curve fitting algorithm.

FIG. 22 illustrates a curve fitting algorithm for determining point loads of one or more vehicles passing on a bridge.

FIG. 23 is a time series displacement showing fluctuations caused by oscillations of the bridge.

FIG. 24 is a flowchart illustrating a method of monitoring a health status of the bridge.

FIG. 25A-25C are different view of a bridge comprising a freeway bypass, wherein FIG. 25A shows a truck on the bypass, FIG. 25B is a first view of the bridge, and FIG. 2C is a second view of the bridge.

FIG. 25D illustrates a displacement as a function of time of a stain on the bridge measured for the truck on the bridge of FIG. 25A.

FIG. 25E is a view of the stain on the bridge that can be used as a marker or target whose displacement as a function of time (time series displacement) is measured using a camera (e.g., as in FIG. 2) to determine the weight distribution according to embodiments described herein.

FIG. 26 is an exemplary hardware and software environment used to implement one or more embodiments of the invention.

FIG. 27 schematically illustrates a typical distributed/cloud-based computer system using a network to connect client computers to server computers during the implementation of one or more embodiments of the present invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

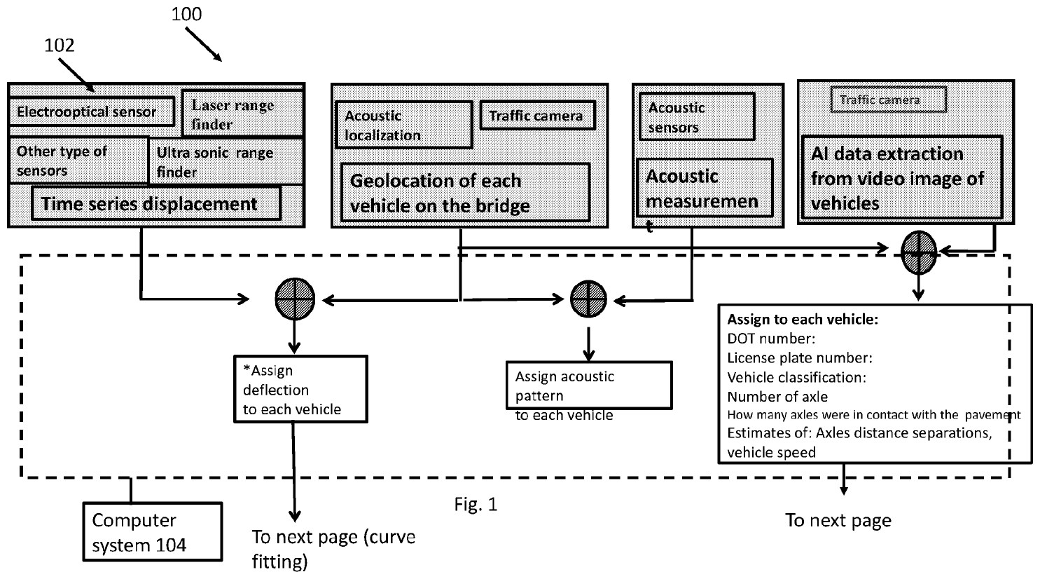

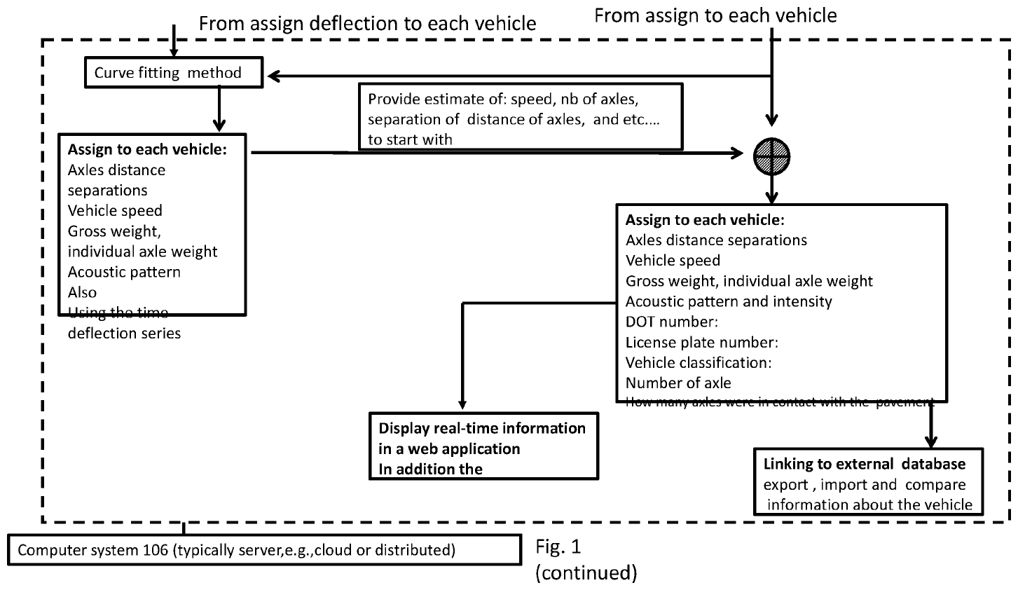

FIG. 1 illustrates a non-invasive automated system 100 and method for measuring one or more properties or characteristics of a vehicle (e.g., weight, dimension, noise, speed, license plate number, the type of the vehicle, the vehicle's Department of Transportation number in the case of a commercial vehicle) simultaneously and without interfering with traffic. In one or more examples, the same system determines in real-time the dynamics of the monitoring bridge.

In various examples, the vehicle characteristic is deduced from the displacement of one or more targets mounted on the bridge. A variety of sensors 102 may be used to deduce the target displacement. In one or more examples, multiple sensor types are aggregated to the system. Each type of sensor may be selected based on its suitability for deducing target(s)' displacement in a specific frequency range. Moreover, different sensor types may be used to expand the working frequency range of the target's time-series displacement. These sensors could be invasive as well as non-invasive type device.

A computer system is used to determine the identifying characteristic from the measurement data outputted from the sensors. In various examples, the computer system comprises a distributed computer system comprising a client computer 104 attached to the sensor or edge devices and a cloud or server 106 for determining the weight distribution from the sensor data. There are different ways of assigning a deflection pattern to a vehicle as it was the only vehicle traversing the bridge. Monitoring visual targets at different locations on the bridge and combining the information with the geolocation of vehicles on the bridge is one method. A second method is to use an algorithm based on neural networks.

Various example sensor and computation modalities are described below.

### A. Example On-Premise (on Site) Sensor Devices

### I. Camera System

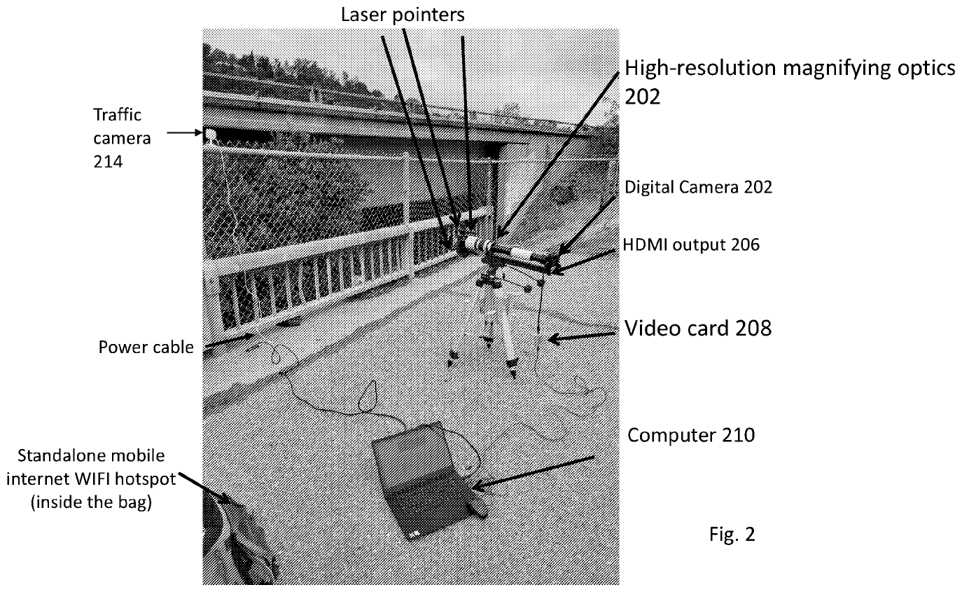

FIG. 2 illustrates an electrooptic system 200, which may comprise one or multiple very high-resolution autonomous camera systems, configured to measure and stream time-series displacement of point target(s) on the bridge in real-time. In one or more examples, the displacement is measured and/or recorded using computer vision methods.

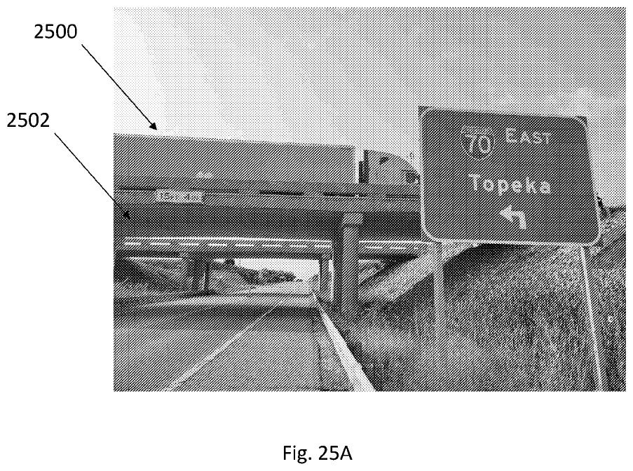

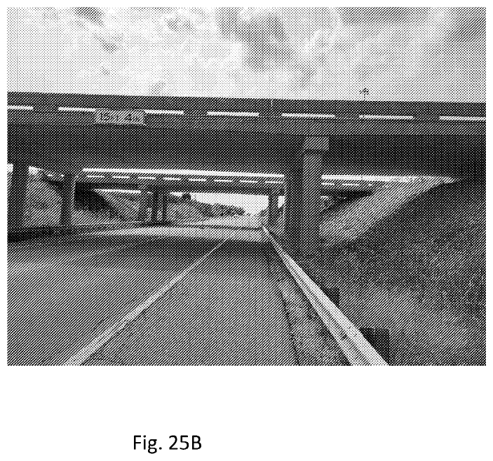

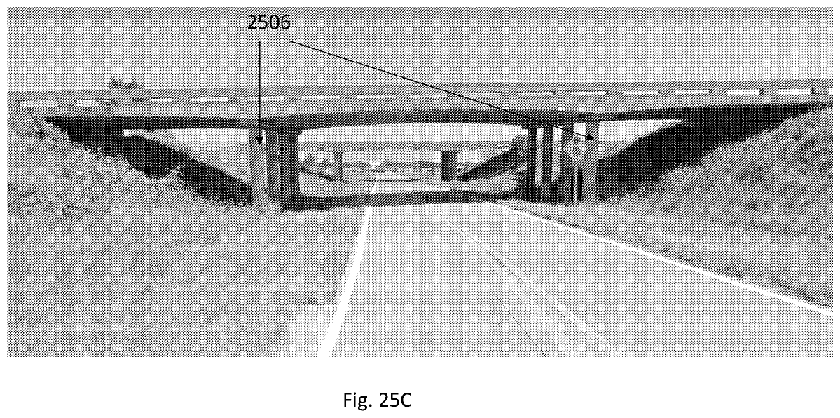

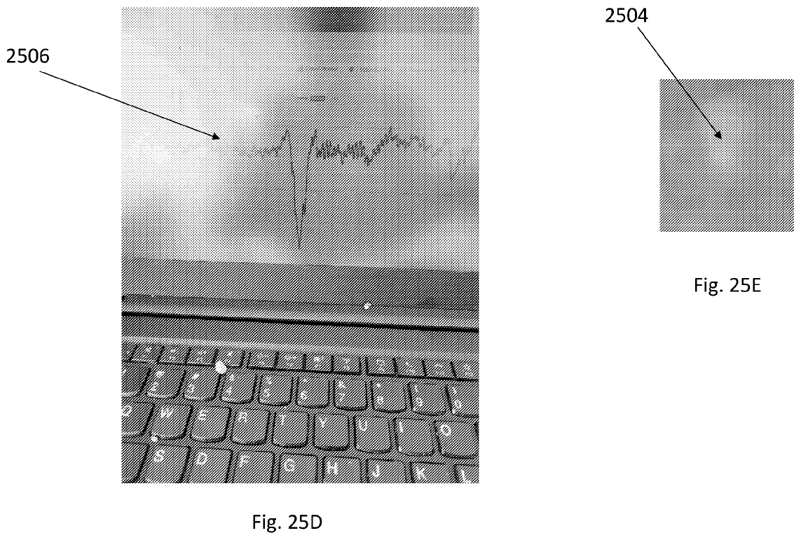

FIG. 2 illustrates the system comprises a digital camera 202; high resolution magnifying optics 204 for focusing light, received from one or more targets on a bridge, on the digital camera; an HDMI output 206 from the camera outputting uncompressed video data formed using the light and comprising motion of one or more target(s) (e.g. a stain on the bridge, as illustrated in FIG. 25E) on the bridge; a video card 208 converting the uncompressed video data into a computer readable image format (e.g., USB 3) comprising image frames; and a computer 210 calculating real time displacement of the target(s) from the computer readable image format.

In one or more examples, the computer 210 calculating the displacement of the targets comprises multiple processing cores capable of parallel processing (e.g., a graphics processing unit, GPU). The multiple processing cores (e.g., GPU) may use parallel processing to find the location of the target(s) in the image frame and calculate their displacements as a function of time.

The system of FIG. 2 further includes a traffic camera 214 (a Wi-Fi IP camera) for streaming traffic through WIFI to a local computer (in the illustrated example, the same computer that computes the bridge time-series deflection, although it could also be a different computer). In other examples, the traffic video images are streamed from flying drones observing the traffic. The computer transforms the video footage from the traffic camera, into the correct format for streaming to the cloud or a remote server computer.

FIG. 2 further illustrates the system includes laser pointers indicating the location of the field of view of the camera. This is especially helpful when using high zoom optics to understand what the camera is observing. Also shown are a power cable for powering the traffic camera and a local mobile wireless connection (e.g., standalone mobile WIFI hotspot) for connecting the system to a remote computer (e.g., the cloud).

In one or more examples, the sensor comprises the electropotic device (for measuring deflections of the target) described in [1].

### II. Rangefinder

The times-series deflection of the bridge can be measured using a range finder aiming a beam at a target on the bridge and recording the beam reflected back from the target. Using the rangefinder, it is possible to determine the time-series displacement of the target (e.g., stain on bridge, as illustrated in FIG. 25E) using a variety of methods including, but not limited to, measuring changes in the distance (time of flight) or interferometry. Time of flight methods typically measure the distance between a sensor and an object based on the time difference between the emission of a signal and its return to the sensor, after being reflected by an object. Interferometry methods typically monitor changes in the phase of the return signal to deduce the displacement of the target. Both approaches can use sophisticated modulation techniques to improve performance and reliability.

Example rangefinder beams emitted from the rangefinder include, but are not limited to, electromagnetic beams (microwave, radar, etc.), optical beams (e.g., a laser beam), or acoustic beams (e.g., sonar, ultrasound, etc.).

### (i) Laser System Rangefinder

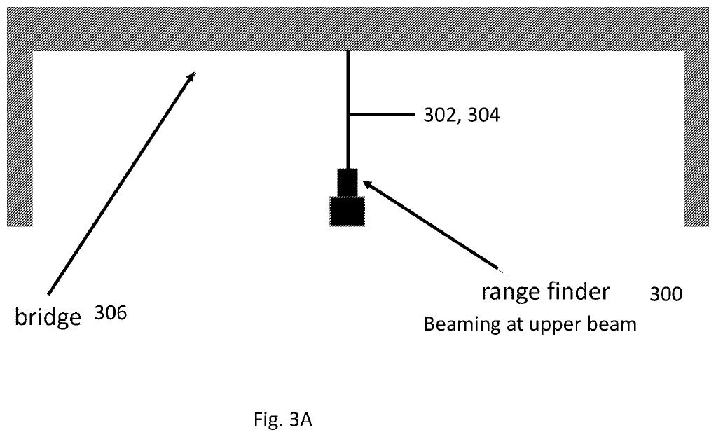

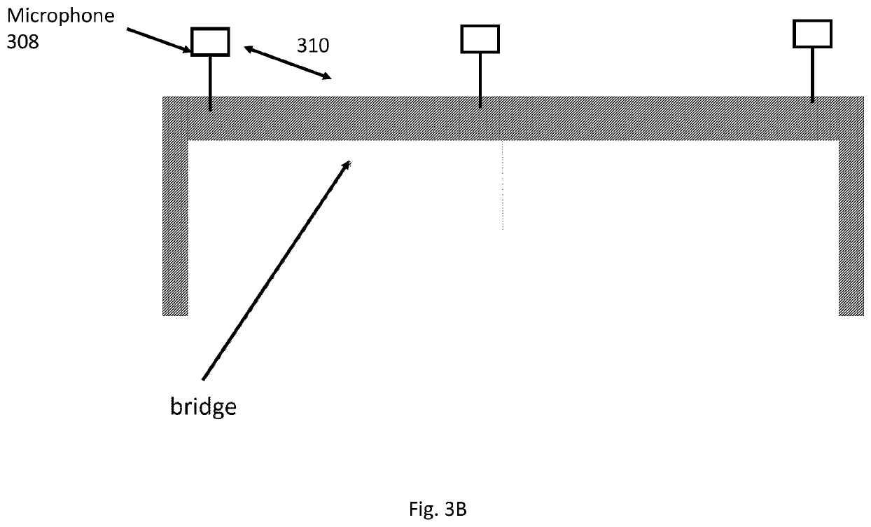

FIG. 3A illustrates an example rangefinder system 300 including one or multiple autonomous laser systems to measure and stream time-series displacement of point target(s) on the bridge in real-time. As the bridge 306 moves/deflects (e.g., due to deflections caused by passing vehicles), the distance between the laser 300 and the bridge 306 changes and the displacement of the target(s) can be deduced from the change in the distance. For each target, a signal or beam or wave 302 comprising a laser beam 304 is beamed to the target and the time it takes the laser beam to reflect back to the rangefinder device is used to calculate the distance. Some laser rangefinders include an internal ‘inclinometer’ which can determine the slope of your target area. In the example of FIG. 3A, the range finder is placed underneath the bridge and the beam is shone on an underside of the bridge. However, other configurations and positioning are possible.

### (ii) Acoustic/Ultra Sonic Range Finder/Sensor

FIG. 3B illustrates an acoustic rangefinder/sensor 308 (e.g., comprising a microphone or ultrasonic emitter) coupled to the bridge. In one or more embodiments, an acoustic/ultrasonic rangefinder uses sound pulses to measure distance, in a similar way to how bats or submarines use acoustic signals for navigation. By emitting an acoustic (e.g., ultrasonic) pulse and timing how long it takes to hear an echo, the acoustic rangefinder can accurately estimate how far away the object is. As with the optical range finder, the acoustic rangefinder can be used to calculate the time-series displacement of the bridge at locations where the range finder emits a signal.

In another example, a series of acoustic and/or ultrasonic sensors may be used detect the position of each vehicle on the bridge, and track the vehicles using an acoustic trilateration method. The acoustic pattern and noise level of each vehicle can be extracted and differentiated from the ambient noise. Each vehicle traversing the bridge emits an acoustic signature detected by the array of synchronized acoustic sensors. By comparing the signal received by the acoustic sensors, the relative phase delays to multiple microphones can be calculated. In this way, time of flight trilateration can be performed, enabling the geo-location of each source of sound and especially the geo location of vehicles traversing the bridge. Then, typical existing and demonstrated tracking algorithms can be applied to predict future positioning of the vehicle based on the history of the individual positions being reported.

In one or more examples, an acoustic signature and intensity can be associated to each vehicle. Large scale deployment of the technology can enable updates and use of a database to identify vehicles using acoustic signature.

In one or more examples, the microphone comprises the microphone described in [2].

(iii) Traffic Camera

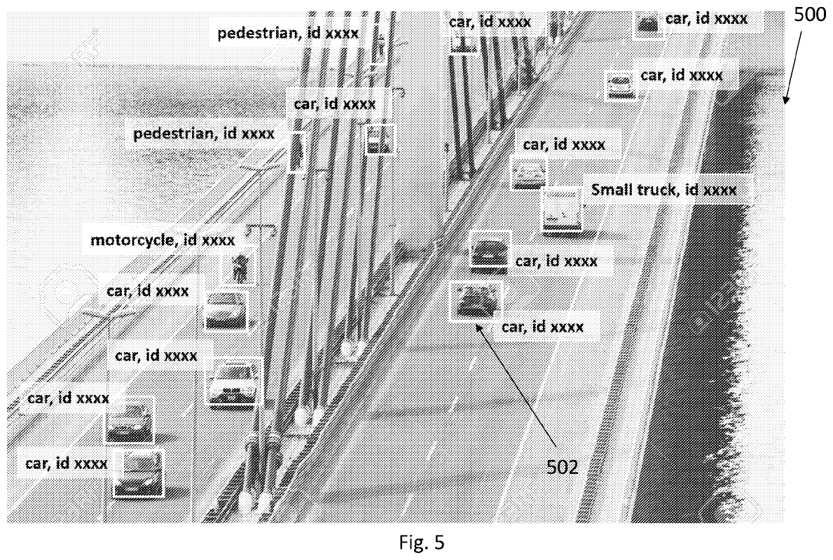

One or more autonomous-and-self-contained traffic camera systems can be used to streaming live views of the traffic to detect and track each vehicle on a bridge and know each vehicle's location at each instant, as shown in FIG. 5 In one or more examples, the traffic video images are streamed from flying drones looking at the traffic.

### B. Example Internet of Things System

In various examples, the data generated by each of the on-premise devices is further processed remotely on the computer system linked to the on premise (on site) sensors.

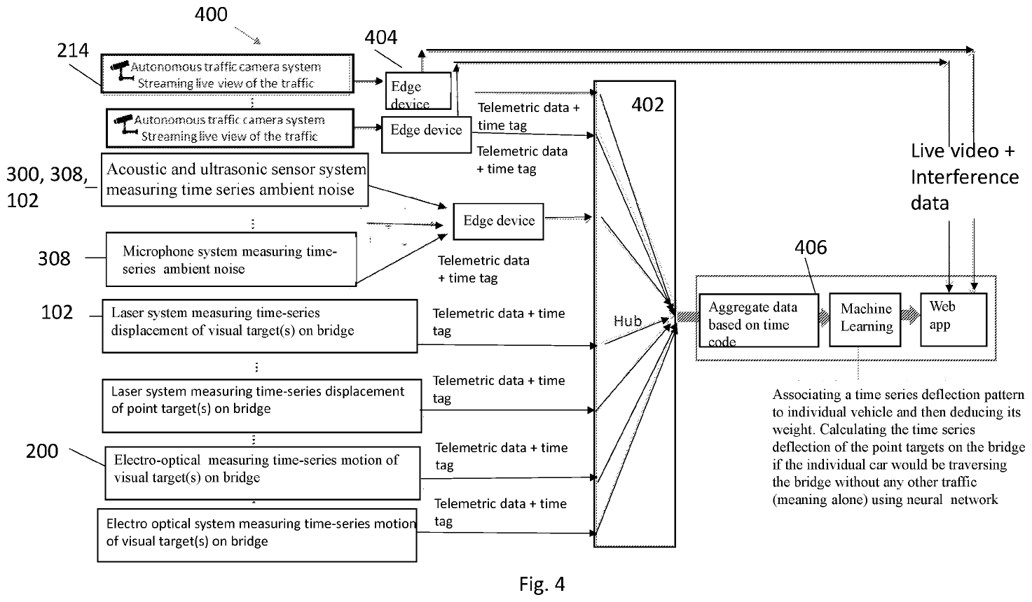

FIG. 4 illustrates an internet of things (IoT) system 400 comprising a hub 402, edge devices 404, the on-premise (on-site) devices 102, and a distrubuted computer system 406 (e.g., comprising a virtual machine or cloud computing system). In one or more examples, the one or more edge device interface the hub with the on premise devices or even perform computation of data.

In a typical example, deflection measurements (time series displacement measurement) are made on site using the on premise sensors (e.g., a camera or a range finder). The sensors may each comprise local or embedded computers or processors configured to perform the processing of the data to obtain the deflection measurements. Moreover, a time tag (using Coordinated Universal Time (UTC) accessible through the internet) is applied to each data recording at the sensor on the site. Due to the time tag on each recording, the data from different sensor can be matched even if different sensors send their data to the remote computer for aggregation and processing at different times. However, in other examples, all sensors can be physically synchronized on site.

The deflection measurement data is then sent to an edge device where the data is collected and further processed.

In various examples, the edge device is a device that provides an entry point to the core of a cloud or a remote computing system. In some examples, edge device perform processing of the data from the sensor prior to being sent to the cloud core. For example, live video streams of traffic captured by the traffic camera can be processed in an edge device using vehicle detection and tracking algorithms. In one or more examples, the edge devices host a processor capable of parallel computing configured for open-source object detection, classification, and tracking, e.g., using different versions of Yolov.

In yet further examples, the processors in the edge device can be configured to implement and train neural networks (e.g., convolution neural network) using custom made and pre-existing training data, e.g., to fine tune the previous classification and detection of vehicles, to detect vehicle size and other characteristics such as, but not limited to, the type of vehicle, color, model year, plate number, number of axles, and axle separations. Open-source data and custom-made training data can be combined to detect object and differentiate pedestrian, bicycle, motorcycle, passenger car, utility car and trucks, small truck, large truck, trailers, truck-tractors, etc.

FIG. 4 shows an example of how object detection algorithms processing one or more live of the traffic obtained from one or more autonomous or standalone traffic cameras can be used to detect and track each vehicle on a bridge so as gain knowledge of each vehicle's location at each instant in time.

IoT edge devices can also be used to detect and track the position of each vehicle on the bridge using acoustic trilateration methods, e.g., by receiving the noise pattern from the on premise acoustic sensor and extracting and differentiating the noise pattern of each vehicle from the ambient noise.

In one or more examples, the edge devices are physical devices. In other examples, the edge devices are virtual machines in the cloud. In one or more examples, the edge device performing object detection in the traffic camera video images comprises multiple processing cores capable of parallel processing (e.g., a graphics processing unit, GPU). Thus the multiple processing cores (e.g., GPU) may use parallel processing to find the identify the objects (e.g., vehicles) in the traffic video footage.

The hub is a bidirectional communications interface that allows communication between the on premise devices, the edge devices and the back end (e.g., core) of the IoT cloud computer. The hub may connect, manage and monitor the IoT devices, for example, managing workflow, data transfer, request-reply, synchronization information, device authentication (per device security keys).

The hub transfers the data from on premise and edge devices to the core of the cloud or remote computing system. Data may be aggregated in the core or the hub based on the UTC time codes time tagged on each data packet sent by devices. In one or more examples, the time tags are synchronized to each other using the most accurate and reliable time references available on the internet or a global positioning system (GPS).

The cloud computing system may comprise on-demand availability of computer resources, including data storage (cloud storage) and computing power, which does not require direct management by the user. In various examples, the cloud may comprise hardware computers and/or server computers, or virtual computing systems or machines, for example. Virtual machines (VMs) may function as virtual computer systems with their own CPUs, memory, network interfaces, and everything else that a physical machine has. Using the cloud, the virtual machines can be provisioned in a few minutes and used immediately. Similarly, we can deprovision them immediately, allowing efficient control of resources. In one or more examples, the deflection (e.g., time series displacement of the bridge measured using a sensor and an onsite computer with GPU) can be streamed in real time to the cloud computing system so that the weight distrubution can be calculated from the displacement data using a web application. In one or more examples, this computation can be performed in real time by provisioning multiple computing services online, but physically located across the country.

The computer system may send the data to a web application for viewing by a user. The web app may show all information (e.g., weight distribution, identifying characteristics) in real time to subscriber end users. In one embodiment, motorists could weigh their vehicle without stopping by subscribing to the system.

### C. Example Computation of Real-Time Time Series Deflection of Point Target(s) on the Bridge

In one or examples, extraction of segments of the visual target's displacement time-series (corresponding to each of one or more vehicles crossing the bridge) is achieved by:
a. Smoothing, filtering, and interpolation techniques (or any related technique) to remove systematics and unwanted noise from the deflection times series in real-time; and/or
b. identifying regions of the displacement time-series corresponding to the vehicle's passages. In various examples, this may be achieved by pattern recognition algorithms applied to bridge displacement time series. In one or more examples, peak detection algorithms are applied to the bridge displacement time series so that the vehicle passage regions are detected from raw deflection time series.

### 1. Example: Using Machine Learning, Neural Networks, or Pattern Recogniition to Allocate Vehicle Weight or Other Vehicle Characteristics

### a. Neural Network

In one or more examples, neural networks are used to associate a times-series deflection pattern to individual vehicles and then deduce the vehicle's weight. Typically the time-series deflection of the point target(s) (e.g., stain as illustrated in FIG. 25E) on the bridge is calculated using the neural network as if the individual vehicle were traversing the bridge without any other traffic (i.e., alone, in isolation from the remaining traffic).

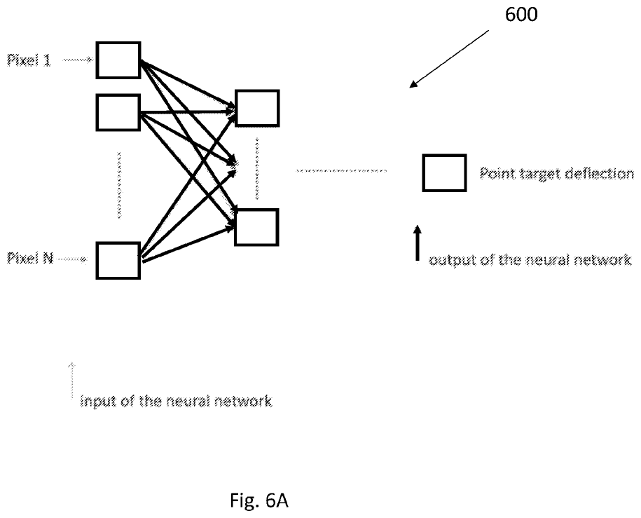

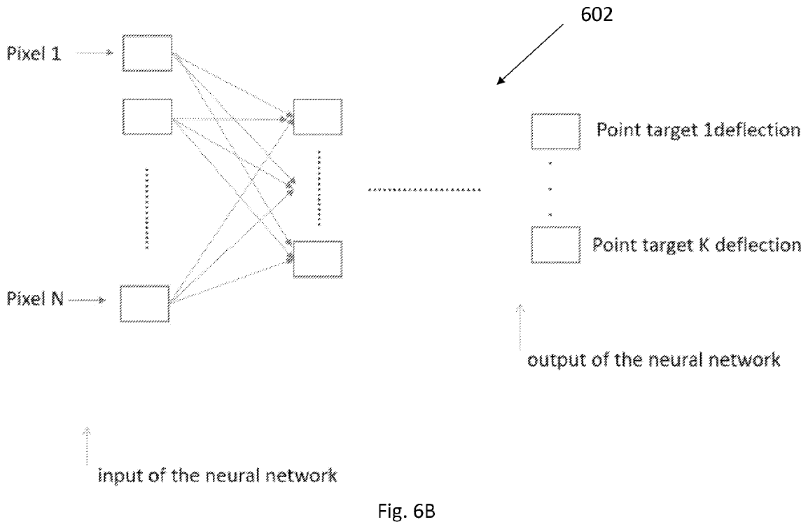

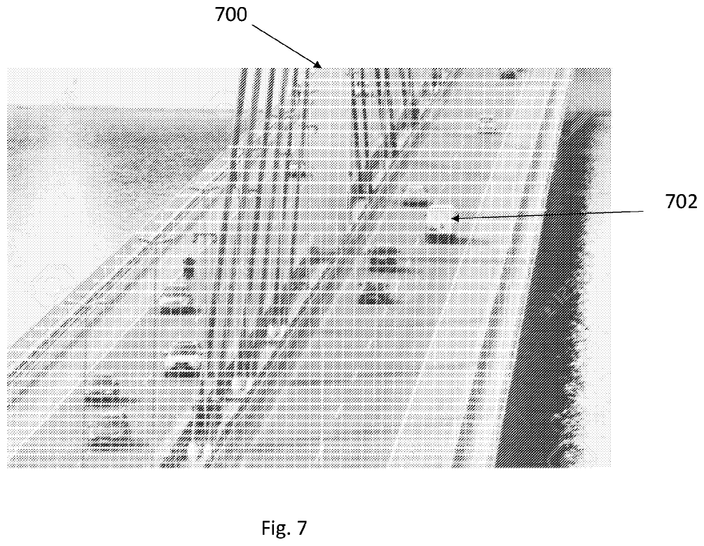

FIGS. 6A and 6B illustrate example neural networks each comprising an input layer configured for receiving a traffic video image (e.g., as illustrated in FIG. 7), a plurality of processing layers for processing the image, and an output layer for outputting an output (e.g., a deflection of a visual target that the system is monitoring).

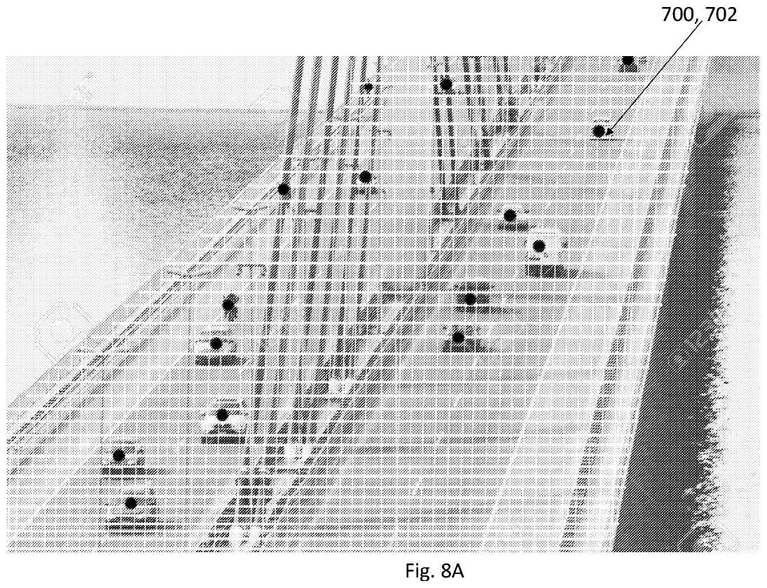

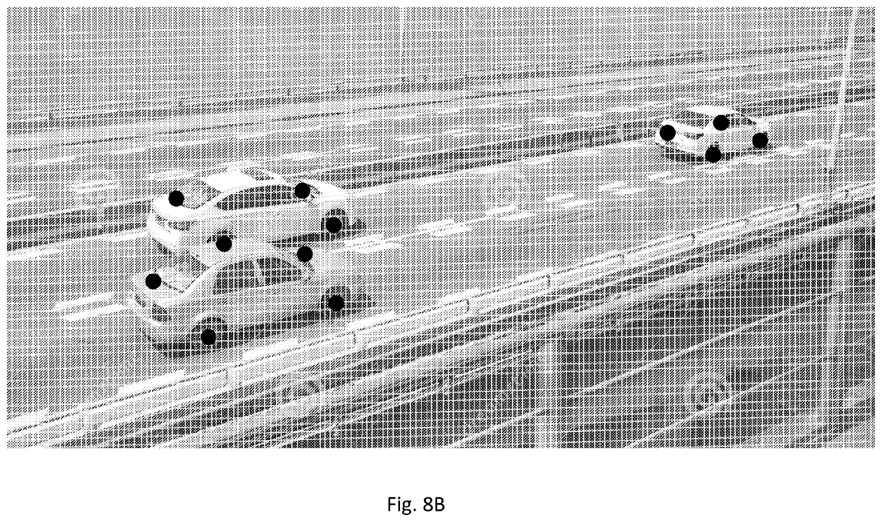

FIG. 7 illustrates the traffic video image comprises pixels 700, wherein each pixel on the traffic video-image is an input to the neural network. As an example, if the center of the visual box surrounding the image of car C₁ at time T₁ is located at pixel(x₁, y₁) on the traffic video-image, then the associated input node of the neural network representing pixel(x₁, y₁) is excited. Similarly, if multiple cars simultaneously traverse the bridge, the input nodes describing the location of those vehicles (or even each point load in a vehicle) are excited at each instant (as illustrated in FIG. 8A and FIG. 8B).

FIG. 6A illustrates an example wherein the output of the neural network is the time-series displacement of one point target (and there are as many neural networks as point targets).

FIG. 6B illustrates an example wherein the output of the neural network is the combination of time-series displacement of all point targets, i.e. Neural Network−Output=

(
time-series_ displacement_ of_ target 1;
time-series_ displacement_ of_ target_ 2;
... ′
time-series_ displacement_ of_ target_ N

In other words, FIG. 6B illustrates an embodiment comprising one neural network having as its input the pixel locations in the traffic video image frame view, where point loads are applied to the bridge at each instant. The neural network output is the concatenation of point target displacements at each instant.

In one or more examples, each vehicle-axle is detected. In this case, the pixel location of each axle is an input to the neural network and each vehicle axle is considered an external point-load to the bridge. This approach allows measurement of the vehicle axle weight in addition to the vehicle's gross weight.

### b. Neural Network Training

Weight and bias and other network characteristics are calculated using training data. In one or more examples, the data collection rate equals the traffic camera's frame rate. If the traffic camera streams video images at a rate of 30 frames per second, then the data collection rate is 108,000 sets of data after an hour and 2,592,000 sets of data after one day. Network parameters can be defined by assigning an average weight to the vehicles traversing a traffic lane, since the number of random vehicles traversing the bridge is very large over the time training data is collected. The calculation may be simplified by using different schemes to group neighboring pixels or regions and associate the groups to the input nodes of neural network.

The size of each pixel inputted to the neural network can be selected in a variety of ways. In one or more examples, each pixel inputted to the neural network is a traffic lane on the bridge. In one or more examples, the weights and biases of each layer in the neural network is configured and trained with the assumption that a length of the same lane of the bridge receives the same amount of traffic over time (i.e., the weight at each location along one lane is on average the same). This is achieved by using sufficiently long training times (in some examples, the training time may be a plurality of hours) so that on average, the traffic and weight experienced by all locations along the length of the lane is the same. Discrepancies in traffic between lanes can be identified by camera accounted for using weighting factors.

The weights and biases for each neural network can also be determined/calibrated by training the neural network using a known vehicle (of known weight) traveling on every lane of the bridge.

### c. Weight Determination using Neural Network

Once the neural network is trained, the neural network can be reversed to deduce vehicle relative loads for each recorded point target displacement. If this method leads to multiple solutions corresponding to different input configurations, the solution corresponding to the location of vehicles on the traffic video image may be selected. With this method, it is unnecessary to calibrate the system to measure vehicle relative weight.

In or more examples, at the same time the system is operating, the neural network may continuously update and train itself so that the system becomes more accurate and reliable as time goes by.

Translating relative weight measurement to weight measurement requires calibration. System calibration can be performed as soon a known-weight vehicle traverses the bridge. In one or more examples, the system is calibrated each time a truck having a known weight is traversing the bridge. Such a known weight truck may be a truck that has been pulled over for weight inspection and whose weight (measured on a scale) has been entered to the system (e.g., via an IoT or cloud system).

In one or more examples, the system utilizing the neural network detects a truck-tractor (without trailer) traversing the bridge, and deduces the vehicle model and characteristics of the truck tractor using AI and deep learning algorithms applied to the traffic video-images. The neural network system then uses the vehicle estimated weight to self-calibrate.

In one or more examples, the system utilizing the neural network at one station is connected to similar systems monitoring other bridges at other stations. If a first one of the stations is adequately calibrated and a vehicle that traversed it then drives on another bridge at a second station, the system monitoring the second station could use the vehicle weight from the first station to self-calibrate.

In one or more examples, the system is connected to nearby weigh stations and uses vehicle weights obtained at the weigh station and traversing the bridge to self-calibrate.

In one or more examples, the system is calibrated correctly to work on a specific type of bridge and therefore it will be calibrated to work on alike bridges.

### d. Example Machine Learning Configurations

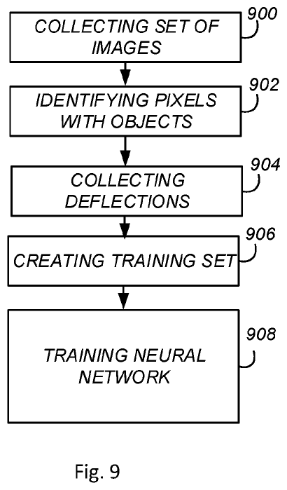

FIG. 9 is a flowchart illustrating a method of training a neural network or artificial intelligence (AI) to identify a load distribution of vehicles on a bridge. The method comprises the following steps.

Block 900 represents collecting a set of images of vehicles on a bridge.

Block 902 represents, for each of the images, identifying which pixels in the image contain a vehicle, to obtain a distribution of pixels representing the positioning of the vehicles.

Block 904 represents collecting a set of deflections (time series of displacements of a target) of the bridge caused by the vehicles traversing the bridge, for each of the images.

Block 906 represents creating a training set comprising the distributions of pixels and the deflections.

Block 908 represents training the neural network by associating the distributions of pixels with the deflection obtained for that distribution, to obtain a trained neural network, so that the neural network is trained to output the deflection in response to the distribution of pixels at the inputs to the neural network.

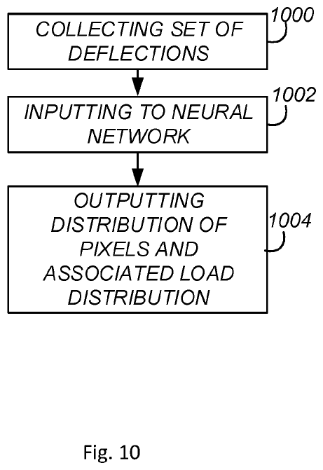

FIG. 10 illustrates a method of identifying a load distribution of one or more vehicles on a bridge. The method comprises the followings steps.

Block 1000 represents collecting a set of deflections of a bridge in response to vehicles traversing the bridge; Block 1002 represents inputting the set of deflections as inputs to the trained neural network so that the neural network outputs a distribution of pixels identifying locations of the vehicles on the bridge and associating the locations with a magnitude of the deflections so as to determine the load distribution (resulting from the passage of the one or more of the vehicles).

Block 1004 represents outputting a comparative weight of the vehicle (e.g., as compared to other vehicles on the bridge, or a comparative weight at each of the pixels (e.g., pixel X corresponds to a location experiencing more than weight than pixel Y because the deflection associated with pixel X is larger than the deflection associated with pixel Y).

Block 1004 represents optionally calibrating the load distribution using a known weight of a vehicle so that the weight of each of the vehicles can be determined using the calibration.

e. Diverse Vehicle Classification Method Using Only the Time-Series Deflection Data of Visual Targets

Vehicle classification method involves applying feature detection/pattern recognition algorithms to time-series displacements of the visual targets. One of those approaches consists of knowing the characteristics of time series deflection of different types of vehicles when traversing a bridge. Knowing the displacement pattern caused by a particular vehicle type when traversing a bridge, cross-correlation can be employed to detect the passage of those types of vehicles.

At some point, as a specific vehicle passes through a bridge, the cross-correlation between its deflection time series characteristics of that specific vehicle type, and the time series of the visual target that is being monitored reaches a maximum peak.

### 2. Example: Curve Fitting to Determine Vehicle Characteristics

In this example, the deflection times series of the bridge associated with the vehicle's passage is fitted to a mathematical function modeling the deflection of the bridge. By choosing the best coefficients for the mathematical model to fit the recorded data, the vehicle's characteristics, such as its axle weights, separations, and speed, can be determined.

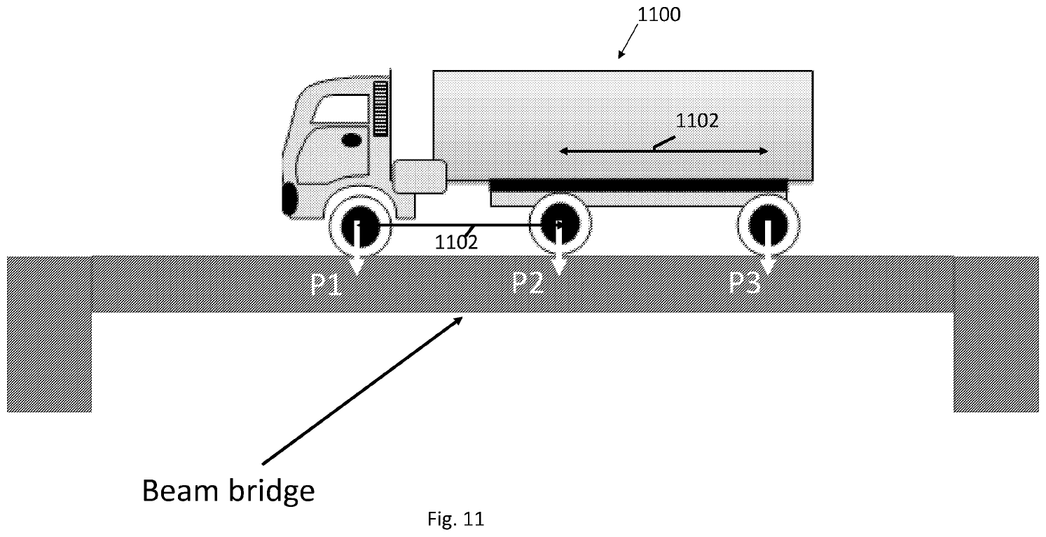

In this model, vehicle loads are transferred to the pavement on the bridge through the vehicle's points of contact with the pavement. Each tire-pavement interaction can be represented as a point load. FIG. 11 illustrates the truck is modelled as a series of point loads moving at the truck's speed. These point loads are separated from each other in the length direction by the same distance as truck axles are separated. In the width direction, the vehicle's point loads are separated by the same distance as its axle rods' length, as illustrated in FIG. 12.

Bridge deflection caused by live loads can be modelled at different levels of complexity. Some advanced numerical models perform a dynamic analysis of the bridge.

In one example, a static model of the bridge can be used to describe the relationship between the bridge's deflection and the static applied loads. In other examples, as more data is collected and a better understanding of the deflections is obtained, the model can be refined, optimized, updated and/or improved to account for both bridge and vehicle dynamics. For example, if the bridge's deflection caused by a single point load is known, a superposition method can be used to describe the deflection of a bridge caused by an ensemble of point loads representing a truck or an ensemble of trucks.

There are a number of factors that affect the shape of the deflection pattern caused by a truck's passage on a bridge, including the bridge length, truck speed, point loads of the truck, point-load separation distances, and location of the bridge where the deflection is measured.

### a. Bridge Deflection Caused by a Point Load Using a Static Model

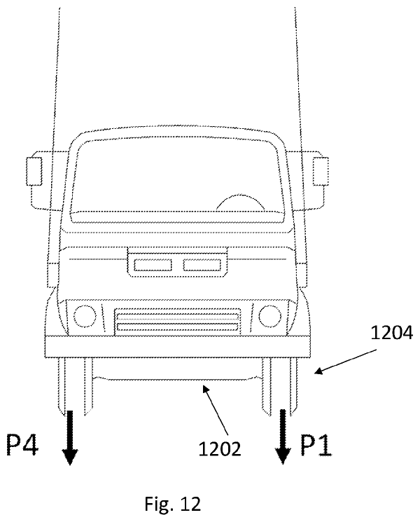

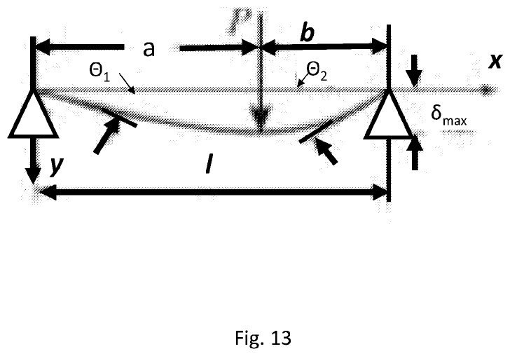

Most highway bypasses are stiff beam bridges which can be modeled as beams simply supported at ends (as shown in FIG. 13), e.g., using an equation describing such a beam simply supported at both ends (e.g., Eq1 and Eq2 below). Also, Eulerian beam theory covers small deflections of a beam, which is suitable for describing small perturbations caused by trucks on bridges.

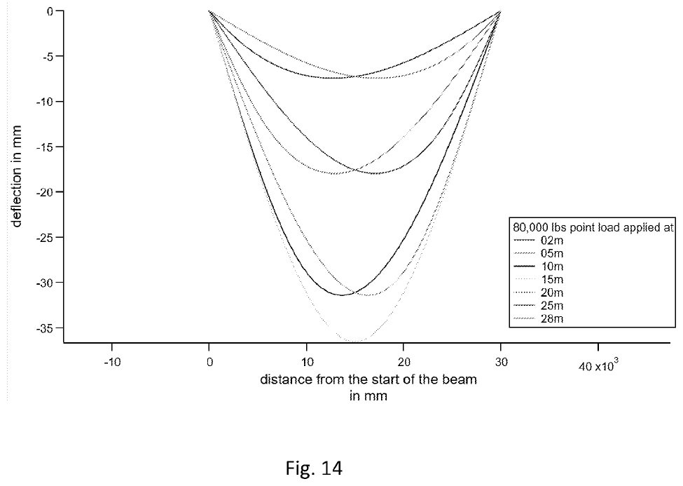

FIG. 14 shows the deflection of a 30 m long beam along its length when P=80,000 lbs point-load is applied at different locations of the beam (in FIG. 4, the deflection of the bridge at location x is y, E is the elastic modulus and I is the second moment of area of the beam's cross section, a is the distance between the point load the front end of the bridge, b is the distance between the point load and the back end of the bridge).

### b. Bridge Time-Series Deflection Caused by the Passage of Point Loads

The same static model can be used to calculate the deflection time-series caused by a single point load traversing the bridge. To do so, a function of time is used to adjust the point load location. In this case, the location of P, expressed with the help of a and b, becomes a function of time. As a result, we can calculate the time-series deflection of the bridge y(t) at the location x caused by the passage of the point-load P.

$$\begin{matrix}y ( t ) = \frac{Pb ( t ) x}{6 lEI} ( {l}^{2} - {x}^{2} - {b ( t )}^{2} ) for 0 < x < a ( t ) \\ y ( t ) = \frac{Pb ( t ) x}{6 lEI} [ \frac{l}{b ( t )} {( x - a ( t ) )}^{3} - ( {l}^{2} - {b ( t )}^{2} ) x - {x}^{3} ] for a ( t ) < x < 1\end{matrix} \qquad Eq 1$$

Assuming P moves at speed ν, b(t) and α(t) are functions of ν.

$$\begin{matrix}a ( t ) = v \cdot ( t - {t}_{0} ) & {t}_{0} \leq t \leq {t}_{1} \\ b ( t ) = l - a ( t ) & {t}_{0} \leq t \leq {t}_{1}\end{matrix} \qquad Eq 2$$

where, t₀ is the time at which the point load enters the bridge, and t₁ is the time at which it exits.

This is the deflection model of a beam simply suspended at both ends. Alternatively, we could use a more advanced displacement bridge model that is based on a numerical structural analysis of the bridge using software such as Etabs or SolidWorks. In other examples, the a dynamic model of the response of the bridge can be used. Thus, other response models of the bridge can be used or optimized. In other examples, the a dynamic model of the response of the bridge can be used. Thus, other response models of the bridge can be used or optimized.

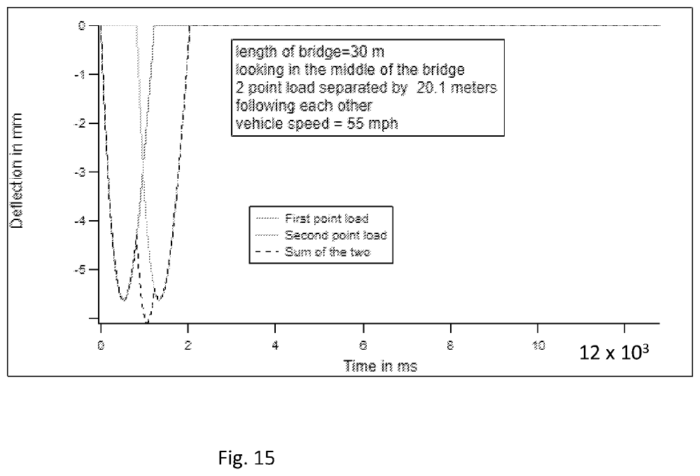

FIG. 15 illustrates the deflection caused by a two axle vehicle traversing the bridge.

### c. Curve Fitting Methodology

In one or more examples, the traffic camera is synchronized with the bridge deflection measurements. A object detection and tracking algorithm is applied in to the traffic video in real time. The traffic camera also records the location of each vehicle on the bridge during each recording with a time stamp that is synchronized with the bridge's deflection measurements. Therefore, every time a bridge displacement is recorded, the exact location and lane of the vehicles responsible is known.

More specifically, synchronization of traffic cameras and bridge deflection measurements can be implemented by associating a time tag with each recording, whether it is a bridge displacement measurement or a traffic video-image recording. Traffic video is processed in real-time on an IoT edge device to detect and track objects. Real-time processing is possible on a GPU-enabled device.

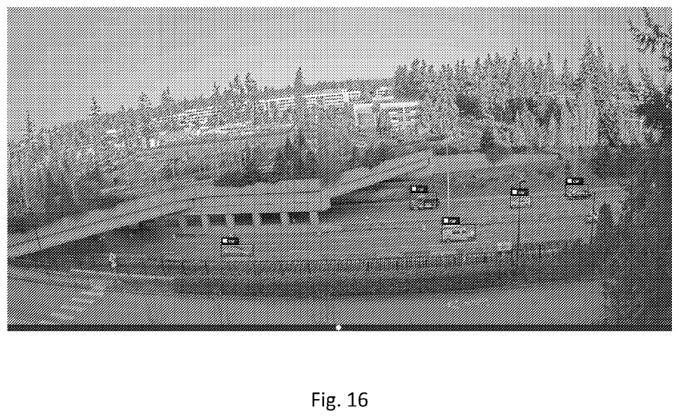

FIG. 16 shows how additionally, in one or more examples, computer vision and artificial intelligence are used to estimate each vehicle's speed, axle number, and axle separation. (Computer vision and artificial intelligence can also be also used to determine each vehicle's DOT number, plate number, type, and model.)

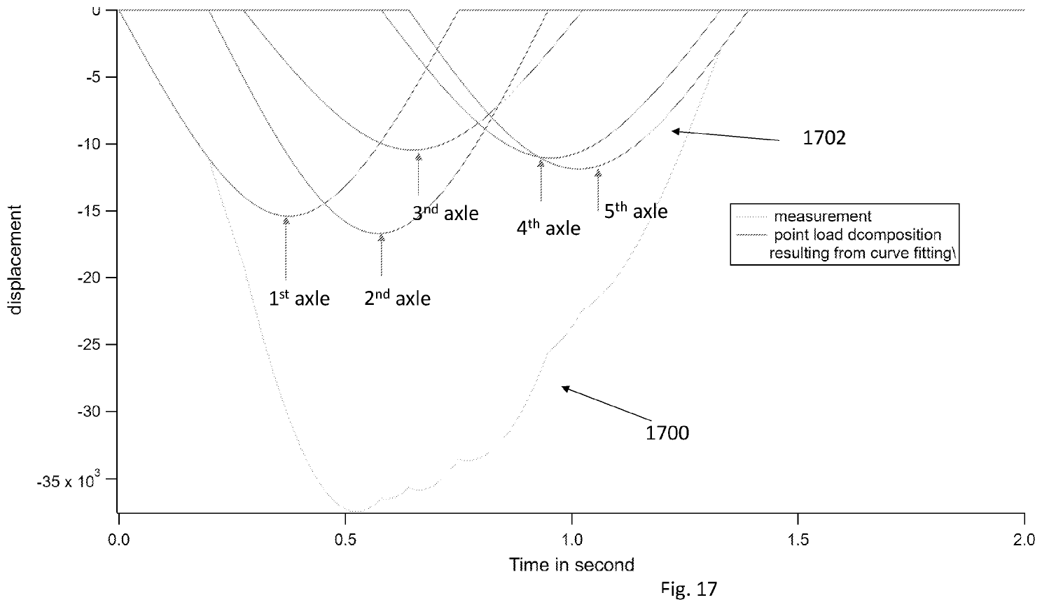

As an initial guess, this information is used to fit a vehicle's deflection pattern to its mathematical model using known curve fitting methods. FIG. 17 is an example measured deflection pattern associated with the passage of a truck.

A curve fitting technique is used to decompose the measurement data (the deflection pattern) into a series of deflections caused by single point loads. Each single point load deflection corresponds to a deflection of a truck axle. The intensity of each peak is proportional to the weight of each axle.

Curve fitting provides a more accurate measure of the vehicle's speed than the initial guess. As a result, the time between different deflections can be used to determine the vehicle's axle distance separations. The data obtained in FIG. 17 was obtained for a typical 5-axle truck, wherein the second and third axles are connected to each other and form a group axle (similarly with the fourth and fifth axles).

In this case, we were only monitoring the deflection of the bridge at one location. Nevertheless, simultaneously monitoring bridge displacement at multiple locations would allow us to interfere with the weight of the car on every one of its wheels.

### d. Example Case when Multiple Vehicles Traverse the Bridge

When multiple vehicles drive on the bridge simultaneously, determining the deflection pattern associated with one vehicle is a typical linear inverse problem. This requires simultaneously solving a set of linear equations. The problem is formally overdetermined and has only one solution available if there are more knowns than unknowns.

The knowns are the total number of observation data points associated with the passage of a vehicle. It is the number of times we record the deflection of the bridge while the vehicle is on it, multiplied by the number of visual targets we observe. Unknowns are the deflection patterns caused by each vehicle traversing the bridge as if it were the only one on the bridge.

The traffic camera also records the location of each vehicle on the bridge during each recording with a time stamp that is synchronized with the bridge's deflection measurements. Therefore, every time we record a bridge displacement, we know the exact location and lane of the vehicles responsible.

Using this information, a deflection pattern can be associated with each vehicle if we consider a single-lane bridge. However, the presence of multiple measurements along the length of the bridge will facilitate the solution, since it will increase the number of knowns.

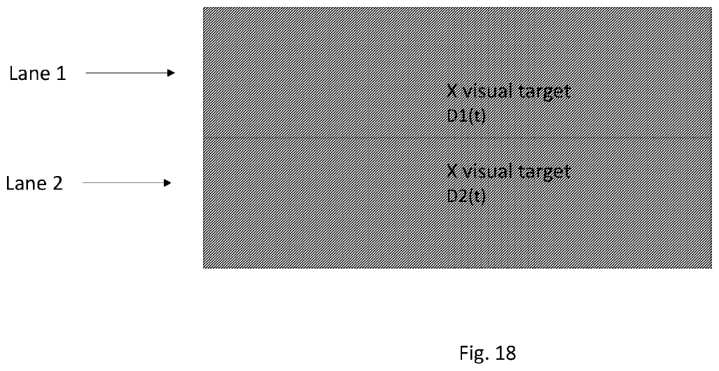

FIG. 18 illustrates a situation wherein multiple vehicles drive simultaneously in adjacent lanes (lane 1 and lane 2) each having a visual target X. The component of the displacement attributable to each vehicle can be determined so long as the number of measurements is equal to or exceeds the unknown.

The deflection of the bridge caused by both trucks on the bridge is given by:

$$( \begin{matrix}{D}_{1} ( t ) \\ {D}_{2} ( t )\end{matrix} ) = K \cdot ( \begin{matrix}{a}_{11} & {a}_{21} \\ {a}_{21} & {a}_{22}\end{matrix} ) \cdot ( \begin{matrix}{T}_{1} ( t - {t}_{1} ) \\ {T}_{2} ( t - {t}_{2} )\end{matrix} )$$

K is proportional to the stiffness o the bridge, T₁(t−t₁) represents the ensemble of moving point loads characterizing a vehicle entering the bridge at time t₁ and driving in lane 1. T₂(t−t₂) represents the ensemble of moving point loads characterizing a vehicle entering the bridge at time t₂ and driving in lane 2.

Let's suppose we calibrate our measurement with a known weight truck T. When no other vehicles are on the bridge, T drives on it in the first lane. We measure the deflection on the first lane D₁(t)_{T=First Lane}, and on the second lane

$${{D}_{2} ( t )}_{T = First Lane} {( \begin{matrix}{D}_{1} ( t ) \\ {D}_{2} ( t )\end{matrix} )}_{T = First Lane} = K \cdot ( \begin{matrix}{a}_{11} & {a}_{21} \\ {a}_{21} & {a}_{22}\end{matrix} ) \cdot ( \begin{matrix}T ( t - {t}_{1} ) \\ 0\end{matrix} )$$

We can assume a₁₁=1. Consequently, the first equation is
D₁(t)_{τ=First Lane}=K·T(t−t₁) and leads to a determination of K.

Then we can use the second equation,
D₂(t)_{τ=First Lane}=K·α₂₁·T(t−t₁) to determine α₂₁,

When T drives in the second lane, we measure the deflection on the lane D₁(t)_{τ=Second Lane}, and on the second lane D₂(t)_{τ=Second Lane}

$${( \begin{matrix}{D}_{1} ( t ) \\ {D}_{2} ( t )\end{matrix} )}_{T = Second Lane} = K \cdot ( \begin{matrix}{a}_{11} & {a}_{21} \\ {a}_{21} & {a}_{22}\end{matrix} ) \cdot ( \begin{matrix}0 \\ T ( t - {t}_{2} )\end{matrix} )$$

The first equation,
D₁(t)_{τSecond Lane}=K·α₂₁·T(t−t₂) leads to a determination of α₂₁.

The second equation, D₂(t)_{τ=Second Lane}=K·α₂₂T(t−₂) leads to determine α₂₂.

Other methods are described in [1].

The further away the vehicle is from the target, the lower the measurement signal-to-noise ratio and the lower the measurement precision. In one or more examples, extending the single lane problem to multiple lanes may be achieved by monitoring each lane separately. In practice, this would involve monitoring visual targets beneath each bridge lane.

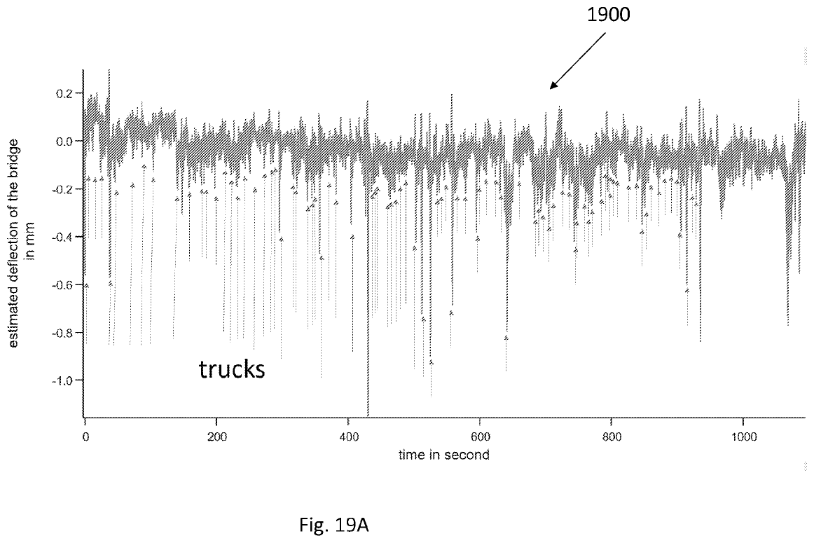

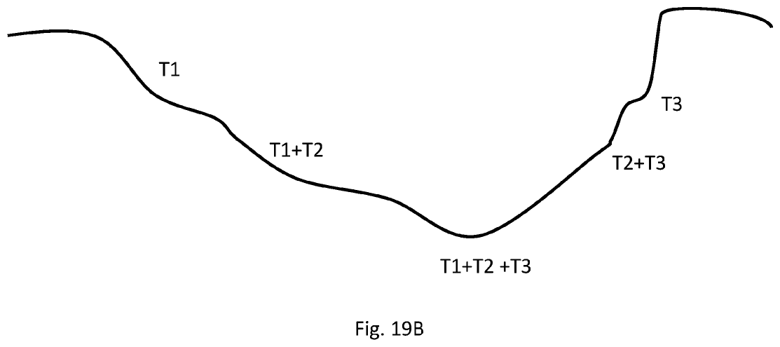

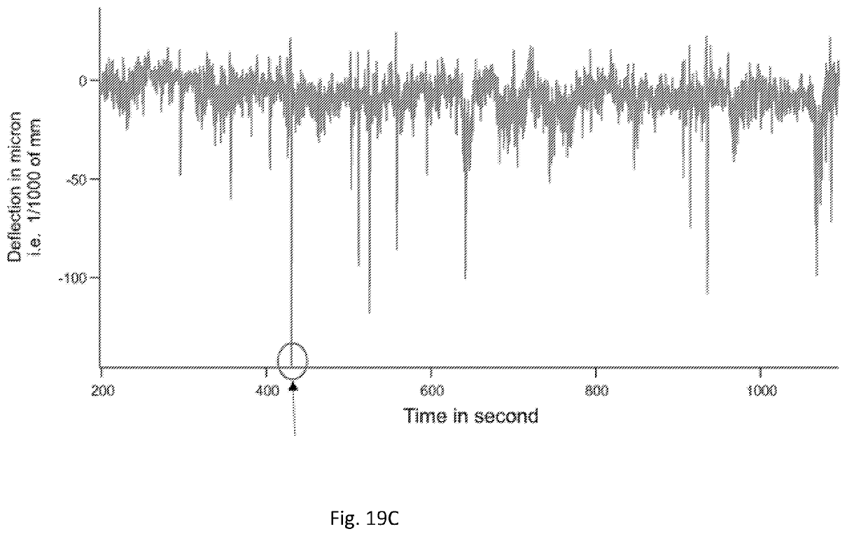

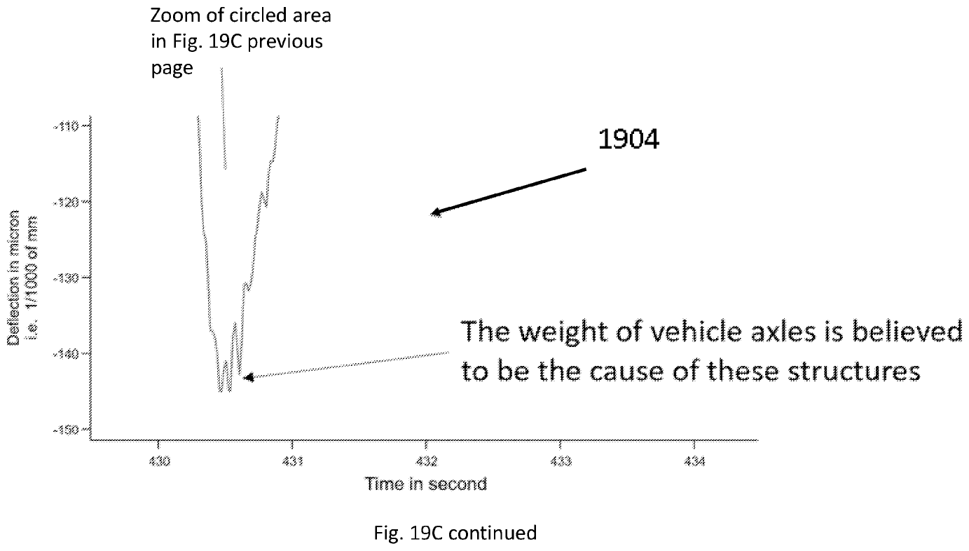

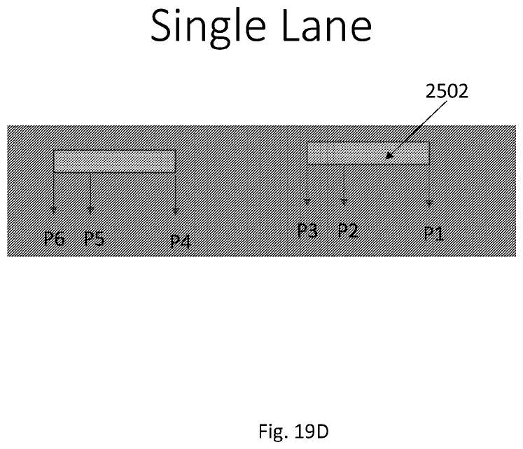

FIG. 19A illustrates a time series deflection measurement indicating the presence of a plurality of trucks traversing the bridge as a function of time.

FIG. 19B illustrates an example zoomed in view of the deflection of a marker showing the deflection includes contributions from different trucks at different moments time, depending on the proximity of each the trucks to the marker: first truck 1 approaches, so the first dip in the deflection results from truck 1 only (T1); then truck 2 approaches and the next dip includes contributions from both truck 1 and truck 2 (T1+T2); then truck three approaches and the next dip in the deflection includes contributions from truck 1, truck 2, and truck 3; then truck 1 leaves the zone of influence on the marker, so the next dip includes contributions from truck 2 and truck 3, and so on. Obtaining the deflection caused by the presence of truck 1 only (T1) enables the deflection caused by T2 to be determined from T2+T1; and knowledge of T2 and T1 enables determination of T3 from T1+T2+T3.

FIG. 19C illustrates how determining the component of the deflection attributable to a single vehicle (from a deflection pattern obtained for a plurality of vehicles) can also be determined using the curve fitting method described above. FIG. 19D shows how the number of point loads P1-P6 for multiple vehicles can be inputted to the curve fitting and assigned as the total number of axles of all vehicles on the bridge (e.g., which can be determined by object recognition in the traffic video). Then, the deflection pattern is fitted using the total number of point loads and the point loads can be assigned to individual vehicles by matching the point loads to the vehicles observed in the synchronized traffic video images.

More specifically, an example curve fitting process may comprise:
1. using traffic camera, determining the locations, relative positioning, and number of point loads can be estimated on the bridge at any time. This information is used as input for curve fitting the time segment of the displacement associated with the trucks of interest traversing the bridge.
2. Using the information in 1 as initial estimates for the variables used in the bridge deformation model.
3. Using the deformation model to match the segment of the displacement time series associated with the trucks of interest traversing the bridge.
4. When the curve fits converge, the variables of the curve fit indicate with accuracy the intensity of each point load, their relative separation, and their speeds.

### e. Example Peak Detection and Curve Fitting Algorithm

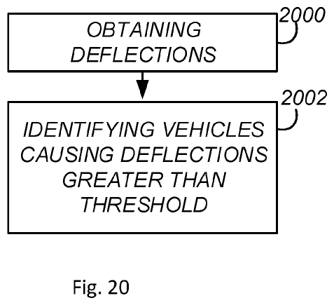

FIG. 20 illustrates a method of determining load distribution of point loads across a vehicle traversing a bridge. The method comprises the following steps.

Block 2000 represents obtaining a deflection of the bridge caused by the vehicle traversing the bridge.

Block 2002 represents identifying a peak in the deflection above a threshold value indicating that the stress on the bridge exceeds an acceptable value.

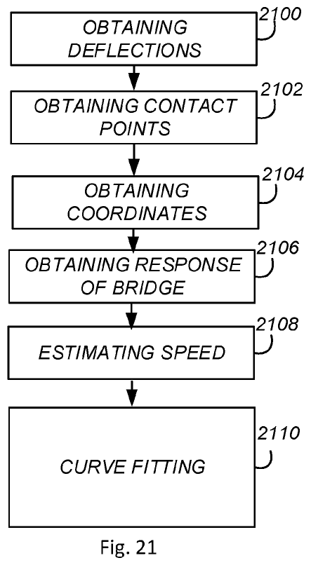

FIG. 21 illustrates a method of determining a load distribution using curve fitting. The method comprises the following steps.

Block 2100 represents obtaining the deflection associated with one of the vehicles traversing the bridge, the deflection obtained by observation of a marker on the bridge.

Block 2102 represents obtaining a number of contact points of the point loads in the vehicle traversing the bridge (number of axles).

Block 2104 represents obtaining a distance of the marker from supports on the bridge and a separation of the point loads.

Block 2104 represents obtaining a plurality of curves representing a response of the bridge to each of the point loads.

Block 2104 represents obtaining an estimate of the speed of the vehicle.

Block 2106 represents curve fitting the deflection as a function of time by summing each of the curves, using a temporal distance between the curves set by the separation divided by the speed, and each of the curves having a spread and maximum peak scaled by the distance of the marker to supports on the bridge; and

Block 2108 represents using the curve fitting to identify each of the point loads in the deflection and determine which of the point loads causes the most stress on the bridge.

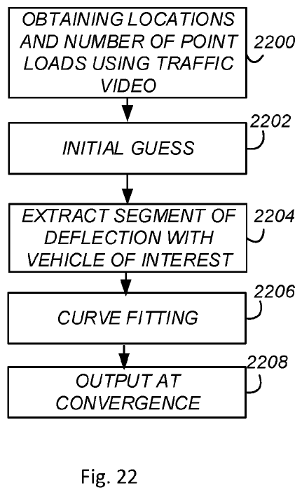

FIG. 22 illustrates a method of using curve fitting to determine the point loads in the presence of multiple vehicles traversing the bridge.

Block 2200 represents using traffic cameras, the locations and number of point loads can be estimated on the bridge at any time.

Block 2202 represents using this information as an initial guess to start the process of curve fitting the curve fit of Block 2204.

Block 2204 represents extracting the segment associated with the time-series displacement at which the vehicle was on the bridge, from the time series displacement of each visual target

Block 2204 represents begin fitting the curve using Blocks 2202 and 2204.

Block 2206 represents when the curve-fit converges, it gives accurate weight, speed, and separation distance for each load traversing the bridge.

Blocks 2200-2206 can be reiterated/repeated each time a vehicle of interest finish traversing the bridge.

### D. Other Examples

Based on the superposition method, we model the deflection time series of the bridge caused by the passage of a vehicle as the sum of the deflections caused by its individual axles:

$${y}_{mid \_ beam} ( t ) = {\sum }_{i = 1}^{i = N} - \vert {A}_{i} \vert \cdot {e}^{- {( \frac{t - {t}_{i}}{Δ T} )}^{2}}$$

where, Ai is the displacement amplitude of axle i, where i={1, . . . , N} is the vehicle axle number,
Ti is the time axle i traverses the middle of the bridge, and N is the number of axles in the vehicle.

The displacement time series can be fitted using various methods, and various methods can be used to determine N.
Applying a multi-peak detection algorithm to the deflection time series created by the vehicle's passage.
analyzing video images captured by traffic cameras using artificial neural networks:
applying ANN algorithm to the deflection time series created by the vehicle's passage.
applying ANN algorithm (more precisely Convolution Neural Network) to the video-image of the vehicle

Then, the fitting coefficients are Ai, ti, and deltaT (if knowing N).

Calibrating the system determines the stiffness coefficient k. The length of the bridge is known or can be measured easily. That is:
deltaT leads to determine the vehicle's speed v.
Ai lead to determine the weight of each axle of the vehicle.
ti in combination with v lead to determine each axle separation of the vehicle

### Locating Peaks in the Time Series.

Multiple methods could be used. Here, we use here a multi-peak detection method based on Gaussian to locate significant peaks in the time series. The time, the width, and the height of each peak are returned as shown.

We can determine the maximum peak deflection that a truck is allowed to induce on the bridge using the peak deflection of a reference truck with the maximum weights and the shortest axle separations moving at the highest speed, whenever a peak deflection exceeds this limit, the truck causes an excessive amount of stress on the pavement, violating the bridge's formulas, (see appendix for more detail).

A deflection pattern associated with the passage of a truck extracted from the deflection time-series shown above.

Based on each peak's location, width, and height, we can develop an algorithm to extract segments of the time series corresponding to deflection patterns larger than a threshold automatically and in real-time. The following deflection is extracted from the deflection time-series data.

### E. Example Bridge Resonance Monitoring

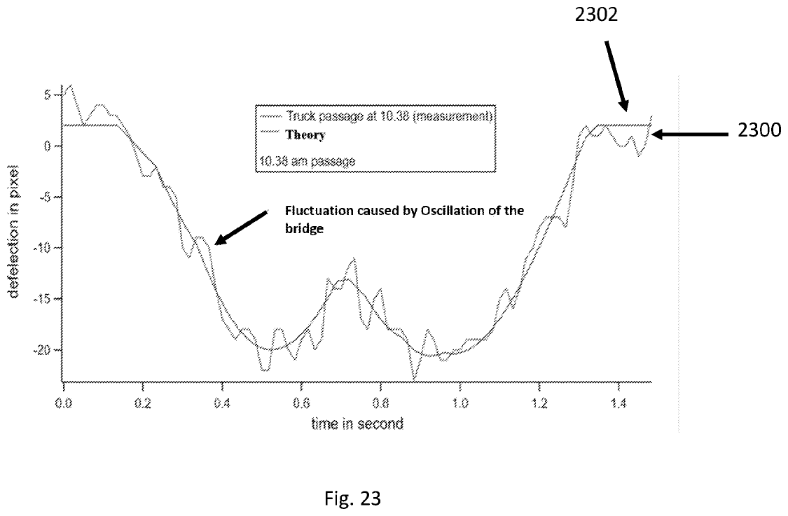

FIG. 23 shows the deflection caused on the bridge by one of the test trucks. The red graph is the measurement and the blue curve is the expected deflection caused by the same truck as estimated by the theory.

The red graph shows the measurement, and the blue curve shows the deflection caused by the same truck as predicted by the theory.

Even though the measurement matched the theory well, the measurement also included an oscillation. (this oscillation could be included in the theory). Bridge vibration is responsible for the oscillation; it is one of the bridge's structural characteristics. Using the power spectrum density of the displacement time-series, we can determine resonance frequencies of the bridge; corresponding to the bridge's various vibration modes. A change in those frequencies may be an indication of structural changes. An early warning system for structural health could be one of its applications.

In another example, our bridge deflection measurement directly distinguishes the maximum stress caused by trucks traversing the bridge. The maximum peak deflection of a vehicle corresponds to the maximum stress it induces on the bridge.

Just observing the deflection of the bridge in functions of time, similar to the ones attached here, makes it possible to identify trucks violating the bridge formula weights without calculating their weight, dimension, or speed.

Suppose we know the maximum peak deflection of an 18-wheeler with a gross weight of lbs. 80,000, with the maximum axle weights and smallest axle separations allowed, induced on the bridge, which we monitor as it traverses at the maximum speed=>This number will correspond to the maximum peak deflection allowed.

Any vehicle traversing the bridge and inducing deflection that exceeds that number violates the bridge formula. To begin, we can require trucks to move on the right lane to mitigate the case where multiple trucks move on multiple lanes. However, the system will eventually assign a deflection pattern to each truck as though it were the only vehicle on the bridge (even though multiple trucks move simultaneously on different lanes).

### Example Bridge Stiffness Monitoring

Monitoring the intensity of deflections can also be used to estimate changes in the stiffness of the bridge.

$$\begin{matrix}δ = k \cdot P \\ δ is the displacement of the bridge under the load P\end{matrix}$$

Stiffness is the coefficient that determines the displacement of the bridge under a load. Stiffness is a structural characteristic of a bridge, and it can indicate structural changes if it changes. An early warning system for structural health could be one of its applications.

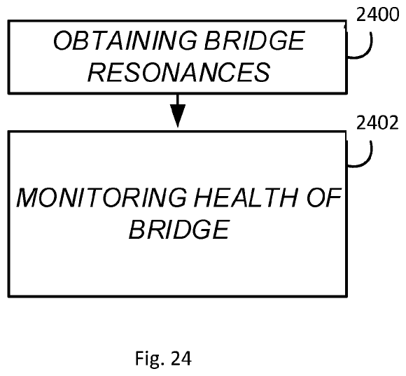

FIG. 24 is a flowchart illustrating a method of monitoring health of a bridge.

Block 2400 represents obtaining bridge resonances by monitoring displacement of the bridge as a function of time (e.g., when trucks pass).

Block 2402 reprsents monitoring the health of the bridge by monitoring changes in the displacement.

### F. Example Bridges

The present invention is not limited by the type of bridge used. Example bridges include, but are not limited to overpasses, freeway bypasses (e.g., as illustrated in FIG. 25A-25C. FIG. 25D illustrates a displacement as function of time obtained by measuring the displacement of the visual target or marker comprising a stain on the bridge (as illustrated in FIG. 25E).

### G. Hardware Environment

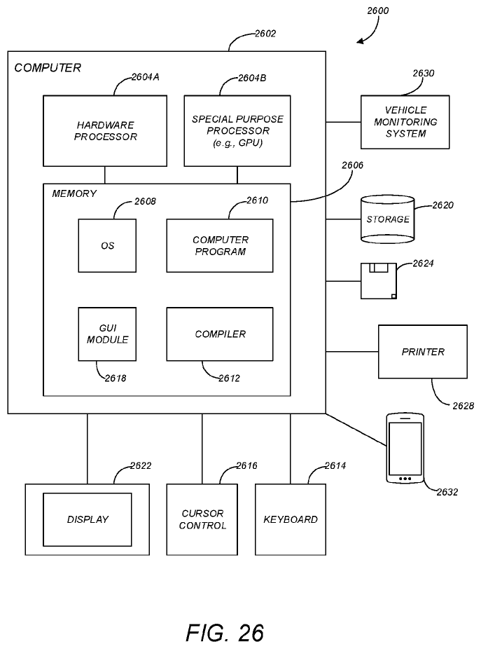

FIG. 26 is an exemplary hardware and software environment 2600 (referred to as a computer-implemented system and/or computer-implemented method) used to implement one or more embodiments of the invention. The hardware and software environment includes a computer 2602 and may include peripherals. Computer 2602 may be a user/client computer, server computer, or may be a database computer. The computer 2602 comprises a hardware processor 2604A and/or a special purpose hardware processor 2604B (hereinafter alternatively collectively referred to as processor 2604) and a memory 2606, such as random access memory (RAM). The computer 2602 may be coupled to, and/or integrated with, other devices, including input/output (I/O) devices such as a keyboard 2614, a cursor control device 2616 (e.g., a mouse, a pointing device, pen and tablet, touch screen, multi-touch device, etc.) and a printer 2628. In one or more embodiments, computer 2602 may be coupled to, or may comprise, a portable or media viewing/listening device 2632 (e.g., an MP3 player, IPOD, NOOK, portable digital video player, cellular device, personal digital assistant, etc.). In yet another embodiment, the computer 2602 may comprise a multi-touch device, mobile phone, gaming system, internet enabled television, television set top box, or other internet enabled device executing on various platforms and operating systems.

In one embodiment, the computer 2602 operates by the hardware processor 2604A performing instructions defined by the computer program 2610 (e.g., a vehicle classification application) under control of an operating system 2608. The computer program 2610 and/or the operating system 2608 may be stored in the memory 2606 and may interface with the user and/or other devices to accept input and commands and, based on such input and commands and the instructions defined by the computer program 2610 and operating system 2608, to provide output and results.

Output/results may be presented on the display 2622 or provided to another device for presentation or further processing or action. In one embodiment, the display 2622 comprises a liquid crystal display (LCD) having a plurality of separately addressable liquid crystals. Alternatively, the display 2622 may comprise a light emitting diode (LED) display having clusters of red, green and blue diodes driven together to form full-color pixels. Each liquid crystal or pixel of the display 2622 changes to an opaque or translucent state to form a part of the image on the display in response to the data or information generated by the processor 2604 from the application of the instructions of the computer program 2610 and/or operating system 2608 to the input and commands. The image may be provided through a graphical user interface (GUI) module 2618. Although the GUI module 2618 is depicted as a separate module, the instructions performing the GUI functions can be resident or distributed in the operating system 2608, the computer program 2610, or implemented with special purpose memory and processors.

In one or more embodiments, the display 2622 is integrated with/into the computer 2602 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 2602 according to the computer program 2610 instructions may be implemented in a special purpose processor 2604B. In this embodiment, some or all of the computer program 2610 instructions may be implemented via firmware instructions stored in a read only memory (ROM), a programmable read only memory (PROM) or flash memory within the special purpose processor 2604B or in memory 2606. The special purpose processor 2604B may also be hardwired through circuit design to perform some or all of the operations to implement the present invention. Further, the special purpose processor 2604B may be a hybrid processor, which includes dedicated circuitry for performing a subset of functions, and other circuits for performing more general functions such as responding to computer program 2610 instructions. In one embodiment, the special purpose processor 2604B is an application specific integrated circuit (ASIC) or field programmable gate array (FPGA) or graphics processing unit (GPU), or multi core processor for parallel processing.

The computer 2602 may also implement a compiler 2612 that allows an application or computer program 2610 written in a programming language such as C, C++, Assembly, SQL, PYTHON, PROLOG, MATLAB, RUBY, RAILS, HASKELL, or other language to be translated into processor 2604 readable code. Alternatively, the compiler 2612 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 2610 accesses and manipulates data accepted from I/O devices and stored in the memory 2606 of the computer 2602 using the relationships and logic that were generated using the compiler 2612.

Example opensource neural network libraries that can be used for implementing the neural networks include, but are not limited to, TensorFlow, Openn, Keras, Caffe, PyTorch

The computer 2602 also optionally comprises an external communication device such as a modem, satellite link, Ethernet card, or other device for accepting input from, and providing output to, other computers 2602.

In one embodiment, instructions implementing the operating system 2608, the computer program 2610, and the compiler 2612 are tangibly embodied in a non-transitory computer-readable medium, e.g., data storage device 2620, which could include one or more fixed or removable data storage devices, such as a zip drive, floppy disc drive 2624, hard drive, CD-ROM drive, tape drive, etc. Further, the operating system 2608 and the computer program 2610 are comprised of computer program 2610 instructions which, when accessed, read and executed by the computer 2602, cause the computer 2602 to perform the steps necessary to implement and/or use the present invention or to load the program of instructions into a memory 2606, thus creating a special purpose data structure causing the computer 2602 to operate as a specially programmed computer executing the method steps described herein. Computer program 2610 and/or operating instructions may also be tangibly embodied in memory 2606 and/or data communications devices, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 2602.

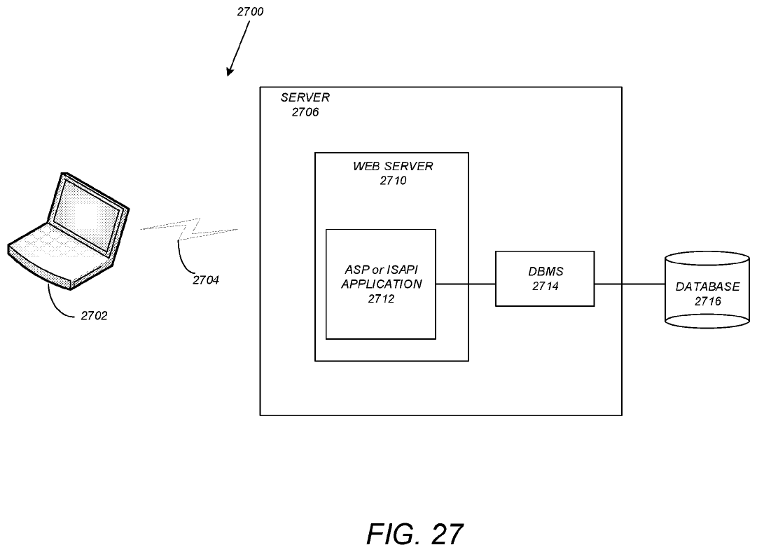

FIG. 27 schematically illustrates a typical distributed/cloud-based computer system 2700 using a network 2704 to connect client computers 2702 to server computers 2706. A typical combination of resources may include a network 2704 comprising the Internet, LANs (local area networks), WANs (wide area networks), SNA (systems network architecture) networks, or the like, clients 2702 that are personal computers or workstations (as set forth in FIG. 26), and servers 2706 that are personal computers, workstations, minicomputers, or mainframes (as set forth in FIG. 26). However, it may be noted that different networks such as a cellular network (e.g., GSM [global system for mobile communications] or otherwise), a satellite based network, or any other type of network may be used to connect clients 2702 and servers 2706 in accordance with embodiments of the invention.

A network 2704 such as the Internet connects clients 2702 to server computers 2706. Network 2704 may utilize ethernet, coaxial cable, wireless communications, radio frequency (RF), etc. to connect and provide the communication between clients 2702 and servers 2706. Further, in a cloud-based computing system, resources (e.g., storage, processors, applications, memory, infrastructure, etc.) in clients 2702 and server computers 2706 may be shared by clients 2702, server computers 2706, and users across one or more networks. Resources may be shared by multiple users and can be dynamically reallocated per demand. In this regard, cloud computing may be referred to as a model for enabling access to a shared pool of configurable computing resources.

Clients 2702 may execute a client application or web browser and communicate with server computers 2706 executing web servers 2710. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 2702 may be downloaded from server computer 2706 to client computers 2702 and installed as a plug-in or ACTIVEX control of a web browser. Accordingly, clients 2702 may utilize ACTIVEX components/component object model (COM) or distributed COM (DCOM) components to provide a user interface on a display of client 2702. The web server 2710 is typically a program such as MICROSOFT'S INTERNET INFORMATION SERVER.

Web server 2710 may host an Active Server Page (ASP) or Internet Server Application Programming Interface (ISAPI) application 2712, which may be executing scripts. The scripts invoke objects that execute business logic (referred to as business objects). The business objects then manipulate data in database 2716 through a database management system (DBMS) 2714. Alternatively, database 2716 may be part of, or connected directly to, client 2702 instead of communicating/obtaining the information from database 2716 across network 2704. When a developer encapsulates the business functionality into objects, the system may be referred to as a component object model (COM) system. Accordingly, the scripts executing on web server 2710 (and/or application 2712) invoke COM objects that implement the business logic. Further, server 2706 may utilize MICROSOFT'S TRANSACTION SERVER (MTS) to access required data stored in database 2716 via an interface such as ADO (Active Data Objects), OLE DB (Object Linking and Embedding DataBase), or ODBC (Open DataBase Connectivity).

Generally, these components 2700-2716 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 2702 and 2706 may be interchangeable and may further include thin client devices with limited or full processing capabilities, portable devices such as cell phones, notebook computers, pocket computers, multi-touch devices, and/or any other devices with suitable processing, communication, and input/output capability.

In one or more examples, the one or more processors, memories, and/or computer executable instructions are specially designed, configured or programmed for performing machine learning or neural networks. The computer program instructions may include a object detection, identification, or computer vision module or apply a machine learning model (e.g., for analyzing data or training data input from a data store to perform the neural network processing described herein). In one or more examples, the processors may comprise a logical circuit for performing object detection, or for applying a machine learning model for analyzing data or train data input from a memory/data store or other device (e.g., an image from a camera). Data store/memory may include a database.

In some examples, the machine learning logical circuit may be a machine learning model, such as a convolutional neural network, a logistic regression, a decision tree, or other machine learning model.

Of course, those skilled in the art will recognize that any combination of the above components, or any number of different components, peripherals, and other devices, may be used with computers 2702 and 2706. Embodiments of the invention are implemented as a vehicle tracking application on a client 2702 or server computer 2706. Further, as described above, the client 2702 or server computer 2706 may comprise a thin client device or a portable device that has a multi-touch-based display.

### Parallel Processing Using Graphics Processing Unit

In various examples, the central processing unit (CPU) contains all the circuitry needed to process input, store data, and output results. The CPU is constantly following instructions of computer programs that tell it which data to process and how to process it.

However, the CPU (central processing unit) is a general-purpose processor that can perform a variety of tasks. The CPU is suitable for a wide variety of workloads, especially those requiring low latency or high performance per core. The CPU uses its smaller number of cores to carry out individual tasks efficiently. It typically relies on sequential computing, the type of computing where one instruction is given at a particular time. The next instruction has to wait for the first instruction to execute. Parallel processing contrasts with sequential processing. It is possible to reduce processing time by using parallelism, which allows multiple instructions to be processed simultaneously.

Parallelism can be implemented by using parallel computers, i.e., a computer with many processors or multiple cores of a CPU. But most consumer CPUs feature between two and twelve cores. GPUs, on the other hand, typically have hundreds of cores or more. This massively parallel architecture is what gives the GPU its high computing performance.

GPU-accelerated computing offloads computer-intensive portions of the application to the GPU, while the remainder of the code still runs on the CPU. So, the GPU works and communicate with the CPU and is used to reduce the workload of the CPU, especially when running parallel-intensive software. More precisely, GPU-accelerated computing offloads compute-intensive portions of the application to the GPU, while the remainder of the code still runs on the CPU. From a user's perspective, applications simply run much faster.

A GPU may be found integrated with a CPU on the same electronic circuit, or discrete (e.g., separate from the processor). Discrete graphics has its own dedicated memory that is not shared with the CPU. In typical examples, the host is the CPU available in the system, the system memory associated with the CPU is called host memory, the GPU is called a device, and GPU memory is called device memory.

In one or more examples, to execute a CUDA program, there are three main steps:
Copy the input data from CPU memory to the GPU memory, also known as host-to-device transfer;
Load the GPU program and execute, caching data on-chip for performance; and
Copy the results from GPU memory to the CPU memory, also called device-to-host transfer.

### H. Device, System, and Method Embodiments

Example methods, devices and systems according to embodiments described herein include, but are not limited to, the following (referring also to FIGS. 1-27 using reference numbers to refer to various features illustrated in the figures):

1. A vehicle monitoring system 100, 400 for determining one or more identifying characteristics of one or more vehicles 2500 traversing (e.g., crossing, driving across, moving across) a bridge 2502, comprising:
a plurality of sensor devices 102 capturing electromagnetic signal or acoustic signals 302 transmitted from a bridge 2502 and/or one or more vehicles 2500 traversing the bridge; and
a computer system 2600, 104, 106, comprising:
one or more processors; one or more memories; and one or more computer executable instructions stored on the one or more memories, wherein the computer executable instructions are configured to determine, from the signals, the one or more identifying characteristics comprising a weight distribution of one or more of the vehicles (e.g., but not limited to, using machine learning, artificial intelligence, neural network, or curve fitting).

2. A device, comprising:
a plurality of sensor devices 102, 200, 300, 308 (e.g., smart sensor device) capturing an electromagnetic signal or acoustic signal 302 transmitted from one or more vehicles 2500 traversing a bridge 2502; and
one or more processors 104, one or more integrated circuits (e.g., FPGA or ASIC), or one or more computers (e.g., client computers 2600) integrated with, embedded with, packaged with, or physically attached to the sensor devices, configured to process the signals into measurement data; and
a transmitter/transsceiver (e.g., WIFI or antenna, or other) configured to output the measurement data to a computer system 2600, 106 comprising one or more servers configured to determine, using the measurement data, one or more identifying characteristics of the vehicles comprising a weight distribution of one or more of the vehicles.

3. A method of monitoring or identifying one or more characteristics of one or more vehicles, comprising:
capturing, e.g. using a plurality of sensor devices, electromagnetic signal or acoustic signals transmitted from one or more vehicles traversing a bridge; and
determining (e.g., calculating), from the signals and using a computer system, the one or more identifying characteristics comprising a weight distribution of one or more of the vehicles.

4. The system, device, or method of any of the examples 1-3, wherein:
the computer system determines, from the signals, the one or more identifying characteristics of one or more of the vehicles comprising axles 1202 connected to tires 1204, and
the characteristics comprising at least one of a department of transportation number, license plate number, a classification of the vehicles (e.g., type of truck, car, van, etc.), a number of the axles on the vehicle, a number of the tires making contact with the bridge, a separation of the axles, a distance of the axles to an end of the bridge, or a speed of the vehicle.

5. The system, method, or device of any of the examples 1-4, wherein:
at least one of the sensors comprises a traffic camera 214 capturing the signals comprising video images 500 of the vehicles traversing the bridge, and
the computer system determines the identifying characteristics from the video images using computer vision or an artificial intelligence algorithm.

6. The system, method, or device of any of the examples 1-5, wherein:
at least one of the sensors comprises a rangefinder 300 irradiating the bridge with the signals 302 comprising electromagnetic radiation, and
the rangefinder determines a displacement of the bridge as a function of time in response to the vehicles traversing the bridge, by measuring changes in a distance to the bridge from changes in a time of flight of the electromagnetic radiation to the bridge or interferometry of the electromagnetic radiation, and
the computer system determines the weight distribution by analyzing the displacement of the bridge.

7. The system, method, or device of any of the examples 1-5, wherein:
at least one of the sensor devices comprises one or more acoustic sensors 308 beaming and/or receiving the signals comprising acoustic signals 310 from the bridge and/or the vehicles on the bridge, and
the acoustic sensors or the acoustic sensors in combination with one or more processors determine at least one of:
a displacement of the bridge as a function of time in response to the vehicles traversing the bridge, by measuring changes in a distance to the bridge from changes in a time of flight of the acoustic signals 310 to the bridge or a triangulation method, the computer system determining the weight distribution from the displacement, or the one or more identifying characteristics of one or more of the vehicles by analyzing an acoustic signature of the acoustic signals.

8. The system, device, or method of any of the examples 1-7, further comprising one or more targets attached to the bridge, wherein:
at least one of the sensor devices comprises a digital camera 202 capturing the signals comprising video images of the target 2504 moving in response to the vehicles traversing the bridge, wherein the video images are marked with a first time stamp; and
the computer system:
determines a displacement 1900, 2506 as a function of time of the one or more targets 2504 from the video images, and
determines the weight distribution from the displacement 1900, 2506.

9. The system, device, or method of example 8, wherein:
at least one of the sensors comprises a traffic camera 214 capturing traffic video images of the vehicles marked a second time stamp so that the traffic video images can be time synchronized to the displacement 1900.

10. The system, device, or method of any of the examples 1-9, wherein:
at least one of the sensor devices comprises a traffic camera 214 collecting the signals comprising forming video images of the vehicles on a bridge, wherein the video images comprise image frames comprising pixels 700;
at least one of the sensor devices measures a set of training displacements of the bridge caused by the vehicles traversing the bridge; and
the computer system executes a training algorithm:
requesting first inputs, for each of a plurality of image frames in the video, identifying which of the pixels 700 are associated with one of the vehicles 702, so that the computer system obtains a training distribution of the pixels representing a positioning of the vehicles in the each of the image frames;
requesting second inputs comprising a set of the training displacements of the bridge time synchronized to the image frames;
creates a training set comprising the training distributions of pixels associated with the training displacements; and
trains a neural network using the training set to obtain a trained neural network 600, 602, so that the trained neural network is trained to output a displacement of the bridge in response to an input comprising a distribution of pixels 700 representing positioning of vehicles on the bridge.

11. The system, device, or method of example 10, wherein the at least one sensor measuring the training displacements comprises:
a rangefinder 300 (e.g., acoustic or electromagnetic signal based) measuring the training displacements by measuring changes in a distance to the bridge as a function of time, or
a camera system 200 recording the training displacements comprising a displacement as a function of time of one or more targets attached to the bridge.

12. The system, device, or method of any of the examples 1-11, wherein:
at least one of the sensor devices comprises a traffic camera 214 collecting the signals forming video images of the vehicles on the bridge, the video images comprising image frames comprising pixels;
at least one of the sensor devices 200, 300 measures of a displacement as a function of time of the bridge caused by the one or more vehicles traversing the bridge; and
the computer system 2600, 104 executes a neural network determining:
a distribution of pixels 700 in one or more of the image frames identifying locations of the one or more vehicles on the bridge in response to the displacement of the bridge inputted to the neural network,
determining the weight distribution by assigning a magnitude the displacement at each of the locations.

13. The system, method, or device of example 12, wherein the computer system:
calibrates the weight distribution using a known weight of a vehicle so that the weight distribution of each of the vehicles at each of the locations can be determined using the calibration, or
outputs a comparative weight of the vehicles from the weight distribution.

14. The system, device, or method of any of the examples 1-11, wherein:
at least one of the sensor devices comprises a traffic camera 214 collecting the signals forming video images of the vehicles on a bridge;
at least one of the sensor devices 200, 300, 308 measures a displacement as a function of time of the bridge caused by the vehicles traversing the bridge;
the computer system:
time synchronizes the images to the displacement;
recognizes the vehicles in the video images; and
determines the weight distribution of one or more of the vehicles by:
associating a segment of the displacement 2300, 1904, 1700 with one of the vehicles 2500 recognized in the video image; and
fitting the segment using a mathematical model 1702, 2302 or by identifying a peak 1702 in the displacement above a threshold level indicating that a stress on the bridge exceeds an acceptable level.

15. The system, method, or device of any of the examples 1-11, wherein:
at least one of the sensor devices comprises a traffic camera 214 collecting the signals forming video images 500 of the vehicles on the bridge;
at least one of the sensors 300, 200, 308 devices measures a displacement of the bridge in response to the vehicles traversing the bridge; and
the computer system determines the weight distribution by:
recognizing one of the vehicles 502 in the video images;
associating a segment 2300, 1904, 1700 of the displacement with the one of the vehicles 502 recognized in the video images; and
curve fitting 1702, 2302 the segment to determine the weight distribution.

16. The system, method, or device of example 15, wherein:
the at least one sensor measuring the displacement comprises a digital camera 200 capturing images of the displacement 2300 a as a function of time of one or more markers attached to the bridge as the vehicles 1100, 2500 traverse the bridge; and
the computer system:
obtains a number of contact points of point loads P1, P2, of the vehicles traversing the bridge;
obtains a distance of the markers (targets 2504) from supports 2506 on the bridge 2502 and a separation 1102 of the point loads P1, P2 (e.g., contact points of the tires on the road);
obtains a plurality of curves 1702 representing a response of the bridge to each of the point loads;
obtains an estimate of the speed of the vehicle;
performs the curve fitting by summing each of the curves 1702, using a temporal distance between the curves set by the separation divided by the speed, each of the curves having a spread and maximum peak scaled by the distance of the marker to the supports on the bridge, so as to obtain fitted data; and
uses the fitted data to identify each of the point loads P1, P2 in the displacement, so as to determine the weight distribution comprising which of the point loads causes the most stress on the bridge.

17. The system, method, or device of example 15 or 16, wherein the computer system determines at least one of the number of contact points, the speed, the distance of the markers, and the separation of the point loads using a machine learning algorithm or computer vision analysing the video images outputted from the traffic camera.

18. The system, device, or method of example 15, 16 or 17 wherein at least one of the sensors comprises a rangefinder 300, 308 determining the distance of the markers and the separation of the point loads.

19. The system, device, or method of any of the examples 1-19, wherein the sensor devices automatically capture the signals and the computer automatically determines the weight distribution from the signals once the system is activated.

20. The system, device, or method of any of the examples 1-19, further comprising:
at least one of the sensors comprising a traffic camera 214 collecting the signals forming video images of vehicles on a bridge;
at least one of the sensor devices 200, 300 measures a displacement of the bridge caused by a plurality of vehicles traversing the bridge; and
the computer system:
determines from the displacement 1904, a contribution to, or segment 1904 of, the displacement caused by a single one of the vehicles as if the single one of the vehicles were the only vehicle traversing the bridge, and
determines the weight distribution from the contribution or the segment.

An internet of things (IoT) system 400 comprising the system of any of the examples 1-19, or the devices of any of the examples 1-19 configured to be linked in the IoT using the transmitter, or the method of identifying of any of the examples 1-19 using the IoT comprising the sensor devices and the computer system, wherein optionally:
at least one of the sensor devices comprises a traffic camera 214 collecting the signals forming video images of the vehicles on a bridge;
at least one of the sensor devices 200, 300 measures a displacement as a function of time of the bridge caused by the vehicles traversing the bridge; and/or
the IoT system further comprises:
one or more edge devices 404 comprising one or more processors executing machine learning or computer vision to identify vehicles in the one or more video images;
the computer system comprising one or more servers 406 or a cloud or distributed system one or more processors; one or more memories; and one or more computer executable instructions stored on the one or more memories, wherein the computer executable instructions are configured to determine the weight distribution of one or more of the vehicles by associating a segment of the displacement with one of the vehicles recognized in the video image time synchronized to the segment 1904; and
a hub 402 linking the servers or the cloud system to the edge devices and the sensors.

21. The system, method, or device of any of the examples 1-20, comprising
at least one of the sensor devices measures a displacement of the bridge caused by a plurality of vehicles traversing the bridge; and
the computer system identifies components of the displacement associated with a structural characteristic of the bridge, wherein the components are useful for monitoring a health status of the bridge.

22. The system, method, or device of any of the examples 1-21, wherein the bridge comprises a freeway bypass.

23. The system, method, or device of any of the examples 1-22, wherein a length of the bridge (e.g., freeway bypass) is only long enough for passage of one vehicle (e.g., truck) at a time.

24. The system, method, or device of any of the examples 1-23, wherein the vehicles comprise one or more trucks.

25. The system, method, or device of any of the examples 1-24, wherein the displacement as a function of time comprises a time series of displacements.

26. The system, method, or device of any of the examples 1-25, wherein the targets or markers on the bridge comprise visual targets or markers such as a bolt or visible feature on the bridge, one or more small holes, one or more stains, discoloration, or any visual mark, or a mark designed with a specific shape that is then attached to the bridge.

27. The system, method, or device of any of the examples, wherein the weight distribution or the load distribution is the amount of the total vehicle weight imposed on the ground at an axle, group of axles, or an individual wheel or plurality of wheels.

28. The method, system or device of any of the examples, wherein the deflection of one vehicle is extracted from the deflection caused by a plurality of vehicles by solving a linear equation. For example, for the case of two trucks on a bridge and two targets attached to the bridge (target 1 attached to lane 1 and target 2 attached to lane 2) the deflection D1 of target 1 and deflection D2 of target 2 due to the presence of both trucks is given by

$$\begin{matrix}D 1 ( t ) = a 1 {1}^{⋆} T 1 + a 12 . T 2 \\ D 2 ( t ) = a 2 {1}^{⋆} T 1 + a 2 2. T 2\end{matrix}$$

$$D = ( \begin{matrix}D 1 \\ D 2\end{matrix} ) = ( \begin{matrix}{a}_{11} & {a}_{21} \\ {a}_{21} & {a}_{22}\end{matrix} ) \cdot ( \begin{matrix}T 1 \\ T 2\end{matrix} )$$

where a11 is a coefficient representing the deflection of target 1 due the presence of truck 1 only in lane 1, a12 is a coefficient representing the deflection of target 1 due to the presence of truck 2 only in lane 2, a21 is a coefficient representing the deflection of target 2 due to the presence of truck 1 only in lane 1, and a22 is a coefficient representing the deflection of target 2 due to the presence of truck 2 only in lane 2. These coefficients a11, a12, a22, a21 can be determined by calibration measurements measuring the deflections when only one of the trucks is traversing the bridge. Then the above matrix equation can be solved for T1 (deflection contribution caused by truck 1 only) and T2 (deflection contribution caused by truck T2 only).

Alternatively, we can define wherein D1(t) as the timeseries displacement measured with the visual target X on lane 1, and D2 (t) as the timeseries displacement measured using the visual target X on lane 2, and then set DeflectionLane1Alone(t) as the Deflection of Lane1 without the other lane and DeflectionLane2Alone(t) is the Deflection of Lane2 without other lane. Then:

$$\begin{matrix}D1 ( t ) = DeflectionLane 1 Alone ( t ) + a 21 DeflectionLane 2Alone ( t ) \\ D\_ 2 ( t ) = DeflectionLane 2Alone ( t ) + a 12 DeflectionLane 1 Alone ( t )\end{matrix}$$

and
α12 is the intensity coupling from lane 1 to lane 2
a21 is the intensity coupling from lane 2 to lane 1
which can be determined by calibration measurements.

29. The system, method, or device of any of the examples, wherein the deflection caused by one vehicle is extracted from the deflection caused by multiple vehicles, by
1. using traffic cameras, the locations and number of point loads can be estimated on the bridge at any time.
2_1) using the information of 1 as an initial guess to start the process of curve fitting the curve fit of 2_2)
2_2) The segment associated with the time-series displacement at which the vehicle was on the bridge is extracted from the time series displacement of each visual target
3) Begin fitting the curve using 2_1) and 2_2)
4) when the curve-fit converges, it gives accurate weight, speed, and separation distance for each load traversing the bridge.
5) reiterate this entire process each time a vehicle of interest finish traversing the bridge.

30. In one or more examples, a large number of systems are monitoring simultaneously a large number of bridges in real-time. In this configuration, each WeighCam station is part of a larger WeighCam network. Data collected from all stations can be used to track freight movement within a region. Using such a system, freight movements and flows can be analyzed and characterized throughout the region.

31. The system, method, or device of any of the examples 1-30, wherein the vehicle comprise autonomous trucks to determine their weight and other characteristics since they cannot be stopped.

32. The system, method, or device of any of the examples 1-31 wherein the weight distribution comprises a measure of vehicle axle weight in addition to the gross weight, when structures (local minimum and maximum values) associated with the vehicle's axles are visible inside the time series of deflection caused by the vehicle as it traverses the bridge. Using this information, the weight of each axle group of the vehicle can be determined.

33, The system, method, or device of any of the examples 1-31, wherein each axle group can be considered as a separate point load. Each axle can be assigned a weight if there are more independent measurements than unknowns, i.e. axle groups from all vehicles, and the vehicle detection and tracking can identify and track each axle group.

34. The system, method, or device of any of the examples 1-33, wherein the system requests input by driver and ship owners and third parties to weigh their vehicles without stopping as the vehicle traverses a weighcam inspection site. As an example, Regulation and inspection of autonomous trucks are challenging due to the fact that are not easy to stop. Law enforcement and regulators seek to monitor these trucks independently from the OEM and fleet owners sharing all trucks' electronic data with them. This problem is solved by the system described here since vehicles are weighed as they pass through the stations.

35. The system, method, or device of any of the examples 1-34 wherein the system is used to trade merchandise and goods without stopping the freight movement. Due to the fact that multiple independent parties have access to a station's output information through subscription, they could use this platform to trade the freight carried by a specific truck based on its weight.

36. The system, method, or device of any of the examples 1-35, wherein the computer system feed a decision-making algorithm with all collected pieces of information about a vehicle to determine whether the vehicle is suspicious or not.

37. The system, method or device of any of the examples 1-36, wherein the weight distribution comprises identification of point loads and the point loads comprise contact points between the vehicle and the road (e.g., pairs of wheels connected to an axle), for example.

38. The system, method, or device of any of the examples 1-37, wherein the computer system executes a web application allowing a subscriber or user to request measurement and viewing of the identifying characteristic (e.g, weight distribution) of a vehicle (e.g., in real time).

39. The system, method or device of any of the examples, wherein the weight distribution, e.g., measured in newtons, comprises a weight in newtons, kg, tons, or other unit.

40. The system, method or device of any of the relevant examples wherein curve fitting methods are be used to classify and characterize vehicles. We can associate each vehicle traversing the bridge with a time-series displacement caused by the vehicle on the bridge if it were the only vehicle. We can fit a mathematical function to the series of data points characteristics of the passage of the vehicle. Vehicle characteristics would be determined by the parameters of the function of the best fit.

41. The system, method, or device for classifying vehicles using acoustic time-series wherein sensors are used to continuously record acoustic time series, wherein the computer system associates the acoustic time series with individual vehicles. Vehicles can be identified by their acoustic pattern characteristics regardless of their appearance.

42. The system, method, or device of any of the examples 1-41, wherein the weight distribution comprises a comparison/output of the relative magnitude of each of the point loads/contact points in the distribution (e.g., P1 is 2 times larger than P2).

43. The system of any of the examples, using curve fitting to identify point loads in the displacement as a function of time obtained for one or more vehicles and associate point loads with specific vehicles using synchronized traffic video footage.

44. A method of making the system or device of any of the examples 1-43, comprising providing or manufacturing the one or more sensor devices and coupling the one or more sensor devices to the computer system, and optionally providing a user interface for providing inputs and outputs to an end user.

### REFERENCES

The following references are incorporated by reference herein.
[1] US Patent Publication No. 20190293518 entitled “New autonomous electro-optical system to monitor in real-time the full spatial notion (rotation and displacement) of civil structures,” patent application Ser. No. 16/359,754, by Shervin Taghavi.
[2] https://www.directindustry.com/industrial-manufacturer/outdoor-microphone-157583.html

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A vehicle monitoring system for determining one or more identifying characteristics of one or more vehicles traversing a bridge, comprising:
a plurality of sensor devices positioned for electromagnetic signals or acoustic signals transmitted from a bridge and/or one or more vehicles comprising point traversing the bridge; and
a computer system configured for:
determining, from the signals:
a displacement of the bridge in response to one or more of the point loads traversing the bridge as a function of time; and
one or more locations of the one or more point loads traversing the bridge as a function of time;
obtaining a model for the displacement as a function of a weight distribution of the point loads, wherein the model models the displacement as a superposition of responses caused by each of the one or more point loads at the locations; and
solving the model for the weight distribution as an inverse problem using the displacement and the locations obtained from the signals.

2. The system of claim 1, wherein:
the computer system determines, from the signals, one or more identifying characteristics of one or more of the vehicles comprising the point loads comprising axles connected to tires, and
the characteristics comprise at least one of a department of transportation number, license plate number, a classification of the vehicles, a number of the axles on the vehicle, a number of the tires making contact with the bridge, a separation of the axles, a distance of the axles to an end of the bridge, or a speed of the vehicle.

3. The system of claim 2, wherein:
at least one of the sensor devices comprises a traffic camera capturing the signals comprising video images of the vehicles traversing the bridge, and
the computer system determines the identifying characteristics from the video images using computer vision or an artificial intelligence algorithm.

4. The system of claim 1, wherein:
at least one of the sensor devices comprises a rangefinder irradiating the bridge with the signals comprising electromagnetic radiation, and
the rangefinder determines a displacement of the bridge as a function of time in response to the vehicles traversing the bridge, by measuring changes in a distance to the bridge from changes in a time of flight of the electromagnetic radiation to the bridge or interferometry of the electromagnetic radiation, and
the computer system determines the weight distribution by analyzing the displacement of the bridge.

5. The system of claim 1, wherein:
at least one of the sensor devices comprises one or more acoustic sensors beaming and/or receiving the signals comprising acoustic signals from the bridge and/or the vehicles on the bridge, and
the acoustic sensors or the acoustic sensors in combination with one or more processors determine at least one of:
the displacement of the bridge as a function of time in response to the vehicles traversing the bridge, by measuring changes in a distance to the bridge from changes in a time of flight of the acoustic signals to the bridge or a triangulation method, the computer system determining the weight distribution from the displacement, or
one or more identifying characteristics of one or more of the vehicles by analyzing an acoustic signature of the acoustic signals.

6. The system of claim 1, further comprising one or more targets attached to the bridge, wherein:
at least one of the sensor devices comprises a digital camera capturing the signals comprising video images of the one or more targets moving in response to the vehicles traversing the bridge, wherein the video images are marked with a first stamp; and
the computer system
determines the displacement as a function of time of the one or more targets from the video images.

7. The system of claim 6, wherein:
at least one of the sensor devices comprises a traffic camera capturing traffic video images of the vehicles marked a second time stamp so that the traffic video images can be time synchronized to the displacement.

8.-9. (canceled)

10. The system of claim 1, wherein:
at least one of the sensor devices comprises a traffic camera collecting the signals forming video images of the vehicles on the bridge, the video images comprising image frames comprising pixels;
the model comprises a trained neural network and the computer system determines the weight distribution by reversing the trained neural network and selecting the weight distribution as a solution of the model corresponding to the locations recorded using the video images.

11. The system of claim 10, wherein
path weights and biases of the trained neural network are determined by training the neural network using a known one of the vehicles having a known weight traveling on every lane of the bridge.

12. The system of claim 1, wherein:
at least one of the sensor devices comprises a traffic camera collecting the signals forming video images of the vehicles on a bridge;
at least one of the sensor devices measures a displacement as a function of time of the bridge caused by the vehicles traversing the bridge;
the computer system:
time synchronizes the images to the displacement;
recognizes the vehicles in the video images; and
determines a weight distribution of one or more of the vehicles by:
associating a segment of the displacement with one of the vehicles recognized in the video images; and
fitting the segment using the mathematical model or by identifying a peak in the displacement above a threshold level indicating that a stress on the bridge exceeds an acceptable level.

13. The system of claim 1,
at least one of the sensor devices comprises a traffic camera collecting the signals forming video images of the vehicles on the bridge; and
the computer system determines the weight distribution by:
recognizing one of the vehicles in the video images;
associating a segment of the displacement with the one of the vehicles recognized in the video images; and
solving the model comprises curve fitting the segment to determine the weight distribution.

14. The system of claim 13, wherein:
the at least one sensor measuring the displacement comprises a digital camera capturing images of the displacement a as a function of time of one or more markers attached to the bridge as the vehicles traverse the bridge; and
the computer system:
obtains a number of contact points of the point loads of the vehicles traversing the bridge;
obtains a distance of the markers from supports on the bridge and a separation of the point loads;
obtains a plurality of curves representing a response of the bridge to each of the point loads;
obtains an estimate of the speed of the vehicle;
performs the curve fitting by summing each of the curves, using a temporal distance between the curves set by the separation divided by the speed, each of the curves having a spread and maximum peak scaled by the distance of the marker to the supports on the bridge, so as to obtain fitted data; and
uses the fitted data to identify each of the point loads in the displacement, so as to determine the weight distribution comprising which of the point loads causes the most stress on the bridge.

15. The system of claim 14, wherein the computer system determines at least one of the number of contact points, the speed, the distance of the markers, and the separation of the point loads using a machine learning algorithm or computer vision analysing the video images outputted from the traffic camera.

16. The system of claim 14, wherein at least one of the sensor devices comprises a rangefinder determining the distance of the markers and the separation of the point loads.

17. The system of claim 1, wherein the sensor devices automatically capture the signals and the computer system automatically determines the weight distribution from the signals once the system is activated.

18. The system of claim 1, further comprising:
at least one of the sensor devices comprising a traffic camera collecting the signals forming video images of vehicles on a bridge;
at least one of the sensor devices measures a displacement of the bridge caused by a plurality of vehicles traversing the bridge; and
the computer system:
determines from the displacement, a contribution to the displacement caused by a single one of the vehicles as if the single one of the vehicles were the only vehicle traversing the bridge, and
determines the weight distribution from the contribution.

19. An internet of things (IoT) system comprising the system of claim 1,
at least one of the sensor devices comprises a traffic camera collecting the signals forming video images of the vehicles on a bridge;
at least one of the sensor devices measures a displacement as a function of time of the bridge caused by the vehicles traversing the bridge;
the IoT system further comprising:
one or more edge devices comprising one or more processors executing machine learning or computer vision to identify vehicles in the one or more video images;
the computer system comprising one or more servers or a cloud system comprising one or more processors; one or more memories; and one or more computer executable instructions stored on the one or more memories, wherein the computer executable instructions are configured to determine the weight distribution of one or more of the vehicles by associating a segment of the displacement with one of the vehicles recognized in the video image(s) time synchronized to the segment; and
a hub linking the servers or the cloud system to the edge devices and the sensor devices.

20. The system of claim 1,
at least one of the sensor devices measures a displacement of the bridge caused by a plurality of vehicles traversing the bridge; and
the computer system identifies components of the displacement associated with a structural characteristic of the bridge, wherein the components are useful for monitoring a health status of the bridge.

21. The system of claim 1, wherein:
the model is expressed as a matrix equation relating a first matrix representing the weight distribution, a second matrix derived using knowledge of the locations of the point loads, and a third matrix representing the displacement as a function of time, and
the computer system solves the matrix equation for the first matrix representing the weight distribution as an unknown using the knowledge of the second matrix and the third matrix obtained from the sensors.

22. A computer implemented method, comprising in a computer system:
receiving signals associated with measurements of:
a displacement of a bridge as a function of time in response to a vehicle traversing the bridge; and
locations of point loads on the vehicle;
obtaining a model for the displacement as a function of a weight distribution of the point loads, wherein the model models the displacement as a superposition of responses caused by each of the one or more point loads at the locations; and
solving the model for the weight distribution as an inverse problem using the displacement and the locations obtained from the signals.
